(19) United States
(12) Patent Application Publication
(10) Pub. No.: US 2006/0136828 A1
(43) Pub. Date: Jun. 22, 2006

(54) System and method for sharing display screen between information processing apparatuses

(76) Inventor: Taiga Asano, Kanagawa (JP)

Correspondence Address: COOPER & DUNHAM, LLP, 1185 AVENUE OF THE AMERICAS, NEW YORK, NY, 10036, US

(21) Appl. No.: 11/301,021

(22) Filed: Dec. 12, 2005

(30) Foreign Application Priority Data
Dec. 16, 2004 (JP) 2004-364633

(51) Int. Cl. G06F 9/00

(52) U.S. Cl. 715/733; 715/751; 715/769; 715/764

(57) ABSTRACT

A system includes a server information processing apparatus having a server function to provide a shared display screen to another information processing apparatus, and a client information processing apparatus having a client function to become a client of the server function, wherein the server function includes a virtual display screen generating unit configured to generate a virtual display screen for accommodating the shared display screen, and a shared display screen acquiring unit configured to acquires image data of at least a portion of the shared display screen displayed on the virtual display screen, and wherein the client function includes a shared display screen receiving unit configured to receive the image data from the server function, and a shared display screen displaying unit configured to display at least a portion of the shared display screen on a shared display screen presenting area in response to the received image data.

### BACKGROUND OF THE INVENTION

1. Field of the Invention

The present invention relates to a display screen sharing system, a display screen sharing method, and a record medium having a display screen sharing program that allow a plurality of information processing apparatuses to share a display screen.

2. Description of the Related Art

In recent years, there has been a trend that not only files are exchanged through personal computers between a plurality of users, but also the display screen of a personal computer is shared for the purpose of holding a conference, so that discussion can be held while using the display screen of someone else's personal computer.

Further, there have been an increasing number of situations in which a network administrator may copy files to a plurality of personal computers under his/her management, or may operate personal computers remotely. There have also been an increasing number of cases in which an individual uses a plurality of personal computers simultaneously.

There is thus a need for data existing on one personal computer to be fetched to another personal computer for use therein. The data existing on a remote personal computer may be fetched by copying the file through the network, or may be fetched by allowing the local personal computer to access the file by use of a shared folder. Further, there is software available on the market that allows a user to control another personal computer remotely as if the user is sitting at the personal computer.

The technology that allows the sharing of files and the sharing of a display screen between a plurality of personal computers include the following examples.
(A1) FTP (File Transfer Protocol)
(A2) File Sharing provided in Windows (registered trademark)
(A3) SPANWorks (conference system, http://www.spanworks.com/)
(A4) Pick-and-Drop (Sony Computer Science Laboratories, Inc., Mr. Rekimoto, http://www.csl.sony.co.jp/person/rekimoto/pickdrop/) P0 (A5) Patent Document 1 “File Transfer Method, Apparatus, and Record Medium Having File Transfer Method Recorded therein”

Further, the prior art relating to display screen sharing includes the following examples.
(B1) Microsoft (registered trademark) NetMeeting
(B2) Microsoft (registered trademark) RemoteDesktop
(B3) VNC (Virtual Network Computing)
(B4) Remote Control Club School Edition (Education System)
(B5) Non-Patent Document 1 (http://www.iplab.is.tsukuba.ac.jp/˜miuramo/comdesk/)
(B6) Japanese Patent Application Publication No. 7-336659, “Communication Apparatus”
[Patent Document 1] Japanese Patent Application Publication No. 7-336659
[Non-Patent Document 1] comDesk (Motoki Miura, et al., “Implementing a Remote Desktop System based on P2P Techniques,” Transaction of Information Processing Society of Japan, Vol. 45, No. 1, Jan. 2004)

In respect of A1, there is software with the function that allows to browse through the directories of an FTP server by use of GUI operations for the purpose of transferring a file. Under some circumstances, however, it takes a lengthy time to reach a desired directory.

There is no FTP server and FTP client that have the function to allow two FTP servers to be connected simultaneously and to handle file transfer between the FTP servers. There is a need to download a file to an FTP client first, and then to upload the file to another FTP server.

A2 allows shared folders for two personal computers (B, C) to be opened on a single personal computer (A), and thereby to allow a file in the shared folder of the personal computer (B) to be transferred to the shared folder of the personal computer (C) by use of a drag-&-drop operation on the personal computer (A). In order to access a desired file and a directory of a transfer destination, however, there is a need to open shared folders by operating the personal computer (A). Under some circumstances, it takes a lengthy time to open the shared folders corresponding to the two desired personal computers.

A3 is software for use in an electronic conference system in which a plurality clients are connected to a single server. This software is provided with the function to transfer files not only between the server and clients but also between the clients by use of the server as an intermediary.

In this system, a file is first transmitted to the server, and, after the reception of the file is completed, the server transfers the file to an intended client. Because of this, the effective speed of file transfer is slow, and the transfer time is simply twice as long.

This system is not provided with such function as provided in A2's personal computer (A) that allows the user of the personal computer (A) to transfer a file from the personal computer (B) to the personal computer (C). Further, there is no function of remote control, so that it is necessary to directly operate client personal computers.

A2 serves to simplify data transfer between two personal computers. An object such as a file displayed on a personal computer (A) is specified by use of a special inputting device to which a unique device-specific ID is assigned. This allows the identifier of the personal computer (A) and the identifier of the object to be acquired.

After this, a personal computer (B) specifies the special inputting device, resulting in the identifier of the personal computer (B) being acquired. A server (pen manager) that manages these identifiers instructs the personal computer (A) to transmit the acquired object to the personal computer (B). This achieves a file transfer.

Realization of the operation as described above requires special hardware. Also, a server called a pen manager is needed separately, and there is a further need for the management of identifiers. These are recognized as problems. Further, data that can be transmitted are limited to files and character strings such as URLs. There is no means to handle two personal computers as if they were a single personal computer.

A5 provides for browsing to be performed by use of image data by GUI for the purpose of providing user friendliness to FTP. This system does not provide functionality that makes it possible to operate the personal computer (A), taking the example of A2, to transfer a file from the personal computer (B) to the personal computer (C). Like A1, further, it takes time to search for a desired file and a destination directory.

As described above, with the technologies described above, a sender and a recipient cannot readily specify a file to be transmitted and a folder to receive the file by operating their personal computers. This is the case even if the sender and recipient are sitting side by side as in the case of communication at a conference.

As previously described, the representative examples of display screen sharing software are B1, B2, and B3.

B2 allows a GUI drag-&-drop operation to transfer a file. B1 and software applications based on B3 can achieve file transfer. None of them, however, can achieve the file transfer as described in connection with A2.

When a display screen of an application that the user wishes to show is to be displayed, a setting dialog may need to be popped up separately, and excess labor such as selecting a window may be necessary.

B5 is a combination of B3 and an additionally provided D&D-based file transfer function such as B2. Specifically, the additional file transfer function is as follows. When a file is dragged and dropped on a shared display screen of the display screen sharing system that utilizes the VNC of B3, the path of the file is identified, and the file having the same name is transferred to a predetermined directory provided in a destination personal computer.

Some education software such as B4 or PC management software may have the function to share a display screen between a large number of personal computers, or may have the function to transfer files together at once from the administrating personal computer to administered personal computers or to collect files together at once.

None of these software products, however, achieve file transfer between the windows of the administered personal computers. Further, only a file transfer is achieved, and the transferred file cannot be opened immediately by use of a desired application.

B6 allows a file to be automatically expanded upon the drag-&-drop operation of an icon on the shared display screen, and the contents are pasted onto a file that is currently held open on the shared display screen. This eliminates the trouble of opening the file locally, selecting the displayed contents, and pasting the selected contents on to the file on the shared display screen. Types of applications, onto which the expanded data can be pasted on the shared display screen, are limited.

Further, there is no function that allows operations equivalent to actual GUI operations to be performed. For example, rather than locally expanding a file and pasting the contents on the shared display screen, a file would rather be transferred according to where the file is dropped on the shared display screen (e.g., the file may be dropped onto the desktop, onto a filer such as Explorer, or the like). Alternatively, the file would rather be opened by using an application on the personal computer on which a display screen is shared (e.g., the file is dropped onto an application executable program, a shortcut thereof, a window of an application, or the like).

When the problems of the display screen sharing software that exist today as described above are analyzed, the following issues may be identified. Even though a display screen is shared, individual personal computers are separate from each other, and the sharing of the display screen is achieved in a discontinuous manner. Namely, it is not possible to show a document to a person by physically bringing the document closer to the person, and not possible to show only a portion of the document, while such acts are norm in the real world. Even when the document is of interest to the person, the person cannot see the entirety of the document by bringing it close to the person.

In an example of file transfer, simple tasks such as receiving a box from someone and returning the box after putting documents therein can only be implemented as a cumbersome method in the world of personal computers. That is, an FTP connection is established first, and, then, a file to be transmitted is searched for by browsing through the dictionary of the personal computer, followed by finding a destination directory provided on an FTP server, and then instructing a file transfer.

Even if the display screen sharing software such as B2 that achieves a file transfer through a drag-&-drop operation is used, excess actions for searching for a file and a folder are necessary, and, also, a window of an application that the user does not wish to be seen may be seen by another person. Even when only one application window needs to be shared as previously described, setting operation requires a lengthy time period because of inferior GUI performance.

In the world of personal computers, differing from the real world, space is disconnected from display device to display device between individual personal computers. Even with the sharing of display screens, spatial continuity close to that of the real world does not exist. Namely, there is no mechanism that allows the display screen of one personal computer and the display screen of another personal computer to be presented as if it was a single seamless display screen of a single personal computer. Only unnatural user interface can thus be achieved.

Accordingly, there is a need for a display screen sharing system, a display screen sharing method, and a record medium having a display screen sharing program, which are equipped with a user interface that provides spatial continuity allowing operations close to those in the real world.

### SUMMARY OF THE INVENTION

It is a general object of the present invention to provide a display screen sharing system, a display screen sharing method, and a record medium having a display screen sharing program that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a display screen sharing system, a display screen sharing method, and a record medium having a display screen sharing program particularly pointed out in the specification in such full, clear, concise, and exact terms as to enable a person having ordinary skill in the art to practice the invention.

To achieve these and other advantages in accordance with the purpose of the invention, the invention provides a system for sharing a display screen which includes a server information processing apparatus having a server function to provide a shared display screen to another information processing apparatus, and a client information processing apparatus having a client function to become a client of the server function, wherein the server function includes a virtual display screen generating unit configured to generate a virtual display screen for accommodating the shared display screen, and a shared display screen acquiring unit configured to acquires image data of at least a portion of the shared display screen displayed on the virtual display screen, and wherein the client function includes a shared display screen receiving unit configured to receive the image data from the server function, and a shared display screen displaying unit configured to display at least a portion of the shared display screen on a shared display screen presenting area in response to the received image data.

According to another aspect of the present invention, a method of sharing a display screen between a plurality of information processing apparatuses includes generating a virtual display screen for accommodating a shared display screen, acquiring image data of at least a portion of the shared display screen displayed on the virtual display screen, and transmitting the acquired image data to another information processing apparatus.

According to another aspect of the present invention, a machine-readable medium having a program embodied therein for causing an information processing apparatus to share a display screen with another information processing apparatus includes in the program the machine-code steps of generating a virtual display screen for accommodating a shared display screen, acquiring image data of at least a portion of the shared display screen displayed on the virtual display screen, and transmitting the acquired image data.

According to at least one embodiment of the present invention, it is possible to provide a display screen sharing system equipped with a user interface that provides spatial continuity allowing operations close to those in the real world.

### BRIEF DESCRIPTION OF THE DRAWINGS

Other objects and further features of the present invention will be apparent from the following detailed description when read in conjunction with the accompanying drawings, in which:

FIG. 1 is an illustrative drawing showing the hardware configuration of an information processing apparatus;

FIG. 2 is a block diagram showing a basic system configuration of a display screen sharing system equipped with a file transfer function;

FIG. 3 is a drawing showing the software configuration of a display screen sharing system in which the function to achieve a drag-&-drop operation is added to the basic configuration;

FIG. 4 is an illustrative drawing for explaining an example of a drag-&-drop operation;

FIG. 5 is a flowchart of a process that transfers a file in response to a drag-&-drop operation;

FIG. 6 is a sequence chart showing interactions between information processing apparatuses;

FIG. 7 is an illustrative drawing showing an example of the dragging-&-dropping of a file from one information processing apparatus to another information processing apparatus;

FIG. 8 is a sequence chart showing interactions between the information processing apparatuses;

FIG. 9 is a block diagram showing the configuration of a first embodiment of the display screen sharing system;

FIG. 10 is an illustrative drawing showing an example of a drag-&-drop operation;

FIG. 11 is a sequence chart showing processes performed between the information processing apparatuses;

FIG. 12 is a block diagram showing a configuration in which a display screen sharing server includes a window management unit and a virtual display screen generating unit as additional units, and a display screen sharing client includes a window control unit as an additional unit;

FIG. 13 is an illustrative drawing showing operations on a display according to a second embodiment;

FIG. 14 is a flowchart showing the process of the display screen sharing server according to the second embodiment;

FIG. 15 is a flowchart of the process of the display screen sharing client according to the second embodiment;

FIG. 16 is an illustrative drawing showing an example of a display screen in which a window is shifted according to the second embodiment;

FIG. 17 is a flowchart showing a process performed when the window of an application is moved by operating an information processing apparatus (display screen sharing server);

FIG. 18 is a flowchart of a process performed by the shared display screen is moved by operating an information processing apparatus;

FIG. 19 is an illustrative drawing showing an example of display screen operations according to the second embodiment;

FIG. 20 is a flowchart of a process performed by the window management unit of the display screen sharing server according to the second embodiment;

FIG. 21 is a flowchart of a process performed by the window management unit of the display screen sharing server according to the second embodiment;

FIG. 22 is an illustrative drawing showing an example of display screen operations according to the second embodiment;

FIG. 23 is a flowchart of a process performed by the window management unit of the display screen sharing server according to the second embodiment;

FIG. 24 is a flowchart of a process performed by the window management unit of the display screen sharing server according to the second embodiment;

FIG. 25 is a flowchart of the operation of the display screen sharing server of the second embodiment;

FIG. 26 is an illustrative drawing for explaining the display screen of the second embodiment;

FIG. 27 is a flowchart of a process performed by the display screen sharing server according to a third embodiment;

FIG. 28 is an illustrative drawing for explaining a display screen operation according to the third embodiment;

FIG. 29 is a flowchart of a process performed by the information processing apparatus that receives a file;

FIG. 30 is an illustrative drawing showing the operation that drags and drops a file on an application window;

FIG. 31 is a sequence chart showing exchanges between the display screen sharing server and the display screen sharing client according to a fifth embodiment;

FIG. 32 is a flowchart of a process performed by the display screen sharing client according to the fifth embodiment;

FIG. 33 is an illustrative drawing showing an example of display screen operations according to the fifth embodiment;

FIG. 34 is an illustrative drawing showing an example of display screen operations according to a sixth embodiment;

FIG. 35 is a block diagram of the information processing apparatus shown in FIG. 34;

FIG. 36 is a sequence chart showing an example of the sequence that establishes a cross-connection;

FIG. 37 is an illustrative drawing showing another example of display screen operations according to the sixth embodiment;

FIGS. 38A and 38B are illustrative drawings showing examples of display screens and a system configuration, respectively;

FIG. 39 is an illustrative drawing showing an example of display screen operations according to a seventh embodiment;

FIGS. 40A and 40B are illustrative drawings showing examples of display screens and a system configuration, respectively;

FIG. 41 is an illustrative drawing showing another example of display screen operations according to the seventh embodiment;

FIGS. 42A and 42B are illustrative drawings showing an example of connection by which a plurality of virtual desktop display screens are generated at a single information processing apparatus so as to achieve the sharing of two or more display screens;

FIGS. 43A and 43B are illustrative drawings showing an example in which two display screen sharing clients are connected to a single display screen sharing server so as to share the connections;

FIGS. 44A and 44B are illustrative drawings showing a case in which an information processing apparatus is connected to other information processing apparatuses;

FIG. 45 is a sequence chart showing a process performed by a connection management unit according to an eighth embodiment;

FIG. 46 is an illustrative drawing showing display transitions according to the eighth embodiment;

FIG. 47 is a sequence chart of another process performed by the connection management unit according to the eighth embodiment;

FIG. 48 is an illustrative drawing showing an example of a client list;

FIG. 49 is an illustrative drawing showing the display screen of an information processing apparatus;

FIG. 50 is an illustrative drawing showing display screen transitions according to a ninth embodiment;

FIG. 51 is a sequence chart showing a process performed by the connection management unit according to the ninth embodiment;

FIG. 52 is a sequence chart of a process performed according to a tenth embodiment;

FIG. 53 is an illustrative drawing showing the display screens of information processing apparatuses;

FIG. 54 is a drawing showing an example of a list;

FIG. 55 is an illustrative drawing showing an example of display screen operations according to an eleventh embodiment;

FIG. 56 is a sequence chart of a process performed according to the eleventh embodiment;

FIG. 57 is a sequence chart of a process performed according to the eleventh embodiment; and

FIG. 58 is an illustrative drawing showing the display screen transition of a display screen sharing client according to the eleventh embodiment.

### DESCRIPTION OF THE PREFERRED EMBODIMENTS

In the following, embodiments of the present invention will be described with reference to the accompanying drawings. In the embodiments, elements having the same reference numerals as those already described will not be described repeatedly. Programs referred to in the following embodiments are assumed to use libraries provided by Microsoft (registered trademark), but may as well be created and executed on another operating system.

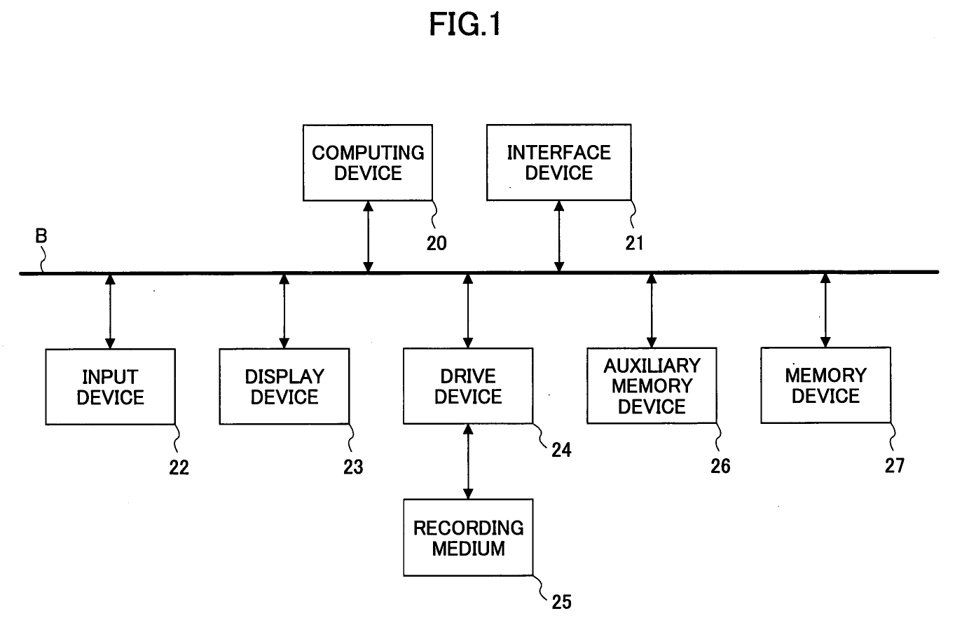

FIG. 1 is an illustrative drawing showing the hardware configuration of an information processing apparatus.

AS shown in FIG. 1, the hardware configuration of the information processing apparatus includes an input device 22, a display device 23, a drive device 24, a recording medium 25, an auxiliary memory device 26, a memory device 27, a computing device 20, and an interface device 21, which are connected to each other through a bus B.

The input device 22 includes a keyboard and mouse or the like, and is used to enter various operation signals into the information processing apparatus. The display device 23 displays various windows and data necessary for the operation of the information processing apparatus. The interface device 21 serves to connect the information processing apparatus to a network or to another apparatus, and is implemented as an NIC (Network Interface Card), modem, USB (Universal Serial Bus), etc.

Programs for making the information processing apparatus operate may be supplied in the recording medium 25 such as a CD-ROM, or may be downloaded through the network. The recording medium 25 is mounted in the drive device 24, so that data and programs are installed from the recording medium 25 to the auxiliary memory device 26 via the drive device 24.

The auxiliary memory device 26 stores data and programs, and also stores files and the like necessary for operation. The memory device 27 stores programs that are read from the auxiliary memory device 26 at the time of power-on of the information processing apparatus. The computing device 20 performs processes according to the programs read and stored in the memory device 27.

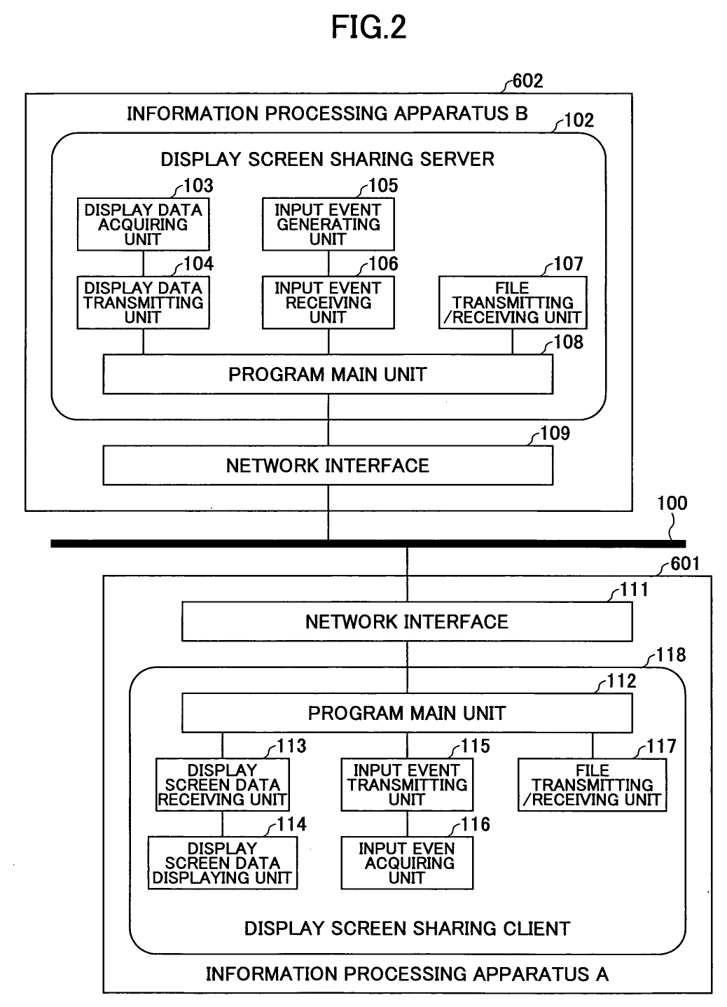

FIG. 2 is a block diagram showing a basic system configuration of a display screen sharing system equipped with a file transfer function. FIG. 2 shows an information processing apparatus A 601, an information processing apparatus B 602, and a network 100 connecting therebetween. The information processing apparatus B 602 serves as a display screen sharing server, and the information processing apparatus A 601 serves as a display screen sharing client.

The display screen sharing server is the one that supplies a display screen, and is controlled by the display screen sharing client. The display screen sharing client is the one that performs remote control while viewing the display screen of the display screen sharing server.

The display screen sharing server and the display screen sharing client are the programs running on separate information processing apparatuses as shown in FIG. 2.

In the following, the software configuration of each of the information processing apparatuses will be described. The information processing apparatus B 602 will be described first. The information processing apparatus B 602 includes a display screen sharing server 102 and a network interface 109. The network interface 109 is the drivers or the like of the interface device described in connection with FIG. 1.

A description will be given of the display screen sharing server 102. The display screen sharing server 102 includes a display data acquiring unit 103, a display data transmitting unit 104, an input event generating unit 105, an input event receiving unit 106, a file transmitting/receiving unit 107, and a program main unit 108.

The program main unit 108 is the main program of the image forming unit 12. The display data acquiring unit 103 acquires a portion or entirety of the display screen data of the display screen that is displayed by the information processing apparatus B 602. The display screen data is compressed according to need and then transmitted by the display data transmitting unit 104 for display on the display screen of the information processing apparatus A 601.

The input event receiving unit 106 receives an event transmitted from the information processing apparatus A 601. The input event generating unit 105 generate the event received by the input event receiving unit 106 inside the information processing apparatus B 602. The file transmitting/receiving unit 107 is a GUI file transfer function that is provided with an FTP server function, and serves to transmit and receive files.

In the following, a description will be given of the information processing apparatus A 601. The information processing apparatus A 601 includes a display screen sharing client 118 and a network interface 111. The display screen sharing client 118 includes a program main unit 112, a display screen data receiving unit 113, a display screen data displaying unit 114, an input event transmitting unit 115, an input event acquiring unit 116, and a file transmitting/receiving unit 117.

The display screen data receiving unit 113 receives display screen data from the information processing apparatus B 602. The display screen data displaying unit 114 displays the received display screen data on the display screen of the information processing apparatus B 602. The input event acquiring unit 116 acquires an event having occurred in the information processing apparatus A 601. The input event transmitting unit 115 transmits the event acquired by the input event acquiring unit 116 to the information processing apparatus B 602. The file transmitting/receiving unit 107 is a GUI file transfer function that is provided with an FTP server function, and serves to transmit and receive files.

With the configuration described above, the information processing apparatus B 602 having the display screen sharing server running thereon can be controlled from the information processing apparatus A 601 having the display screen sharing client running thereon.

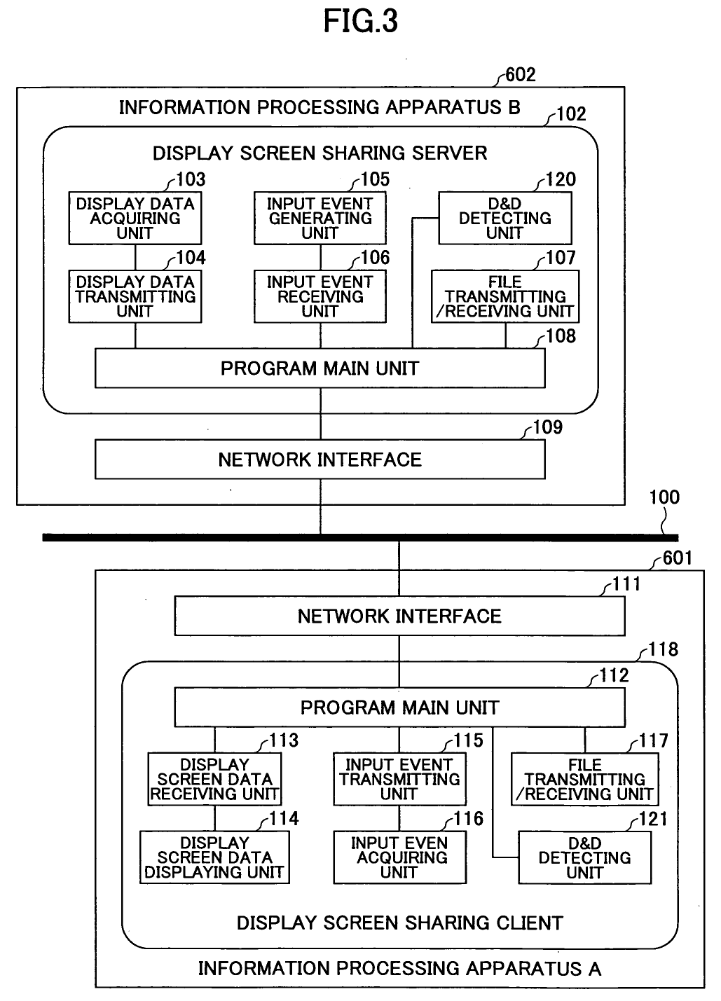

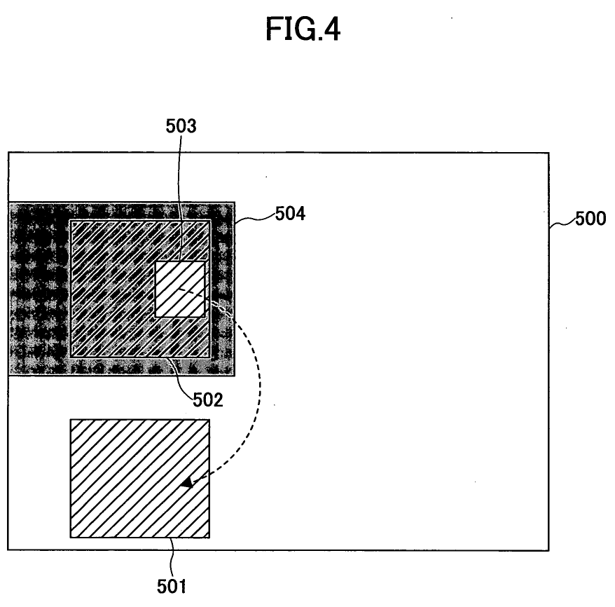

What has been described above is the basic configuration of the display screen sharing system. FIG. 3 is a drawing showing the software configuration of the display screen sharing system in which the function to achieve a drag-&-drop operation is added to the basic configuration described above. FIG. 4 is an illustrative drawing for explaining an example of the drag-&-drop operation.

A drag-&-drop operation refers to a click of a mouse button while the mouse pointer is superimposed on the frame of a window, a file icon (file identifier), or the like on the display screen, followed by shifting (dragging) the mouse, and then releasing (dropping) the mouse button at a different position.

The configuration shown in FIG. 3 includes the configuration shown in FIG. 2 with a D&D detecting unit added thereto. As shown in FIG. 3, the information processing apparatus A 601 and the information processing apparatus B 602 are provided with a D&D detecting unit 121 and a D&D detecting unit 120, respectively.

The D&D detecting unit 121 and the D&D detecting unit 120 function to detect the dragging-&-dropping of a file from a shared display screen or to a shared display screen.

The D&D detecting units provide for the user to perform the operation as shown in FIG. 4. FIG. 4 shows a display screen 500 of the information processing apparatus A 601, a filer 501 of the information processing apparatus A 601, a display screen 504 of the information processing apparatus B 602, and a filer 502 and a file 503 of the information processing apparatus B 602.

The file 503 is situated in the information processing apparatus B 602. The file 503 is dragged and dropped from the filer 502 to the filer 501, thereby transferring the file from the information processing apparatus B 602 to the information processing apparatus A 601.

Specifically, the user selects the file of the information processing apparatus B 602, and drags the file by moving the mouse while pressing down the mouse button. In response, the D&D detecting unit of the display screen sharing server of the information processing apparatus B 602 detects the drag of the file.

While dragging the file, the mouse pointer is moved out of the display screen of the display screen sharing client. In response, the D&D detecting unit of the information processing apparatus B 602 detects that the mouse pointer dragging the file is moved out of the display screen of the display screen sharing client, and acquires the path of the dragged file for temporal storage in memory.

Thereafter, the file is dropped on an information processing apparatus. In response, the D&D detecting unit of the display screen sharing server acquires the destination of the file transfer.

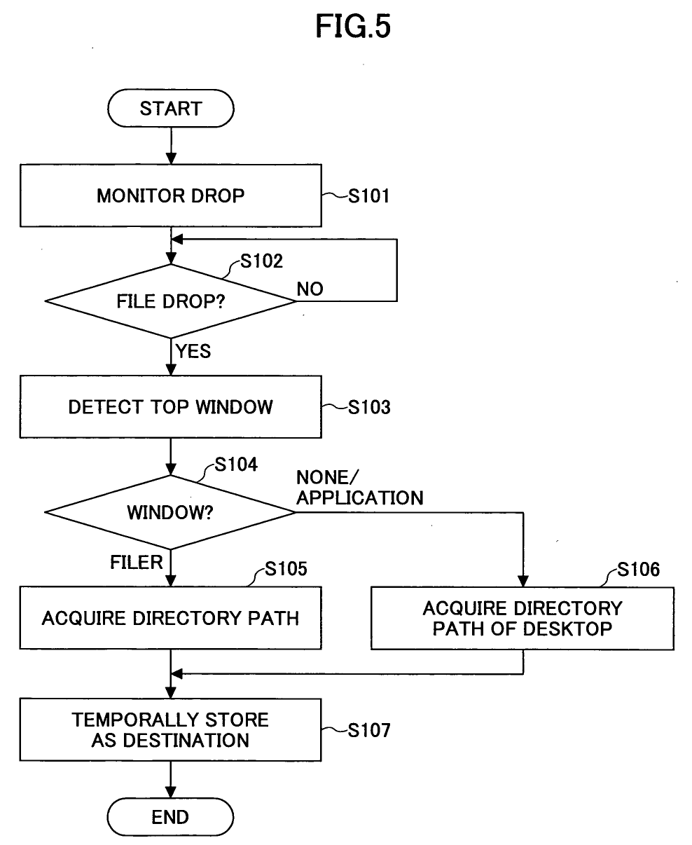

The process described above will be described with reference to a flowchart of FIG. 5. Step S101 is a drop monitoring process performed by the OS (operating system). At step S102, a check is made as to whether the file is dropped.

If it is ascertained that the file is dropped, an item that is positioned at this drop position and has the highest Z order is identified at step S103.

At step S104, a check is made as to whether the item having the highest order is a window. If there is no window or the item having the highest order is an application, the directory path of the desktop is acquired at step S106.

If the item having the highest order is a filer, its directory path is identified at step S105. The identified path is temporarily stored as a destination address.

After the directory path is obtained in this manner, the information processing apparatus A 601 requests the information processing apparatus B 602 to transfer the file, and also informs the information processing apparatus B 602 of the obtained directory path. Upon receiving the request, the information processing apparatus B 602 starts transferring the file indicated by the file path temporarily stored in memory to the specified directory path in the information processing apparatus A 601.

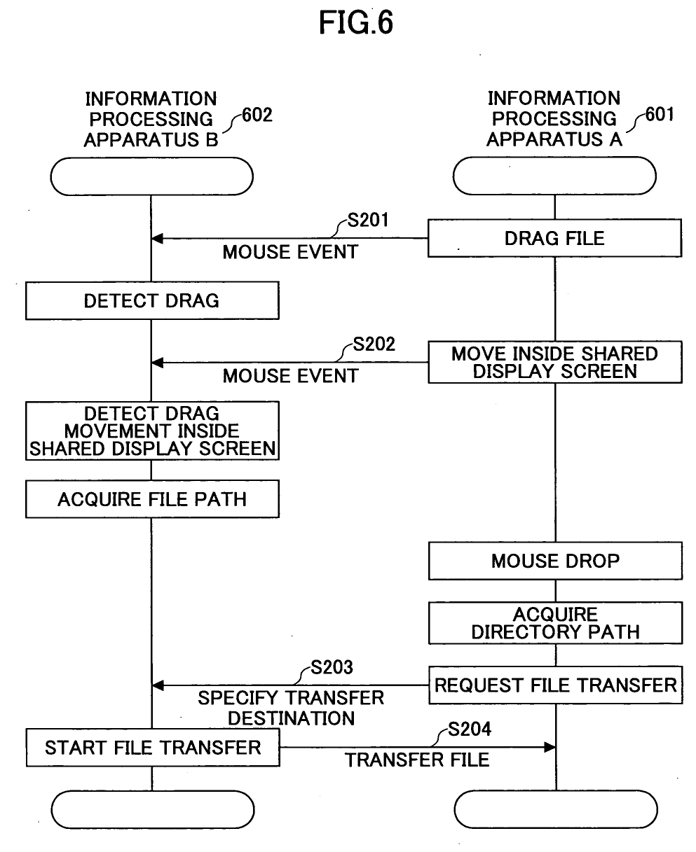

FIG. 6 is a sequence chart showing the interactions between the information processing apparatus A 601 and the information processing apparatus B 602. At step S201, the dragging of a file in the information processing apparatus A 601 is reported as a mouse event to the information processing apparatus B 602.

The information processing apparatus B 602 detects a drag based on this mouse event. The fact that the mouse pointer has moved out of the shared display screen in the information processing apparatus A 601 is reported as a mouse event to the information processing apparatus B 602. In response, the information processing apparatus B 602 detects that the mouse pointer has moved out of the shared display screen. The information processing apparatus B 602 then obtains the file path.

In the information processing apparatus A 601, the file is dropped, and the directory path is identified. At step S203, the information processing apparatus A 601 requests the information processing apparatus B 602 to transfer the file to the specified transmission address. At step S204, the information processing apparatus B 602 starts transferring the file.

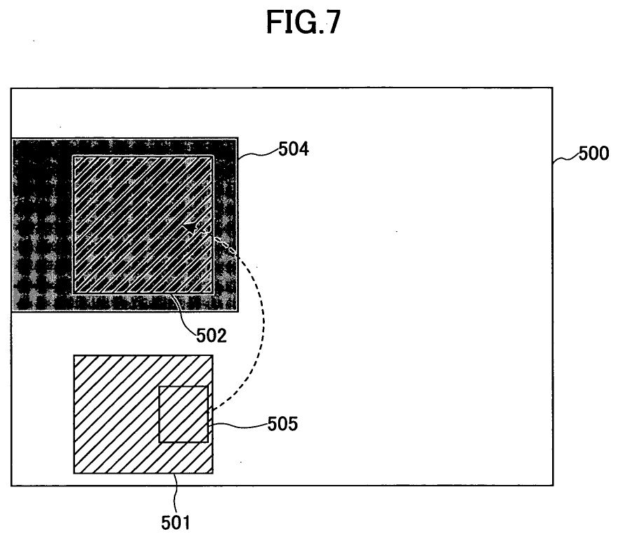

In the following, another example of a file transfer by a drag-&-drop operation will be described with reference to FIG. 7. FIG. 7 is an illustrative drawing showing an example of the dragging-&-dropping of a file 505 from the information processing apparatus A 601 to the information processing apparatus B 602.

The user operates the information processing apparatus A 601 to select the file 505 for transfer through mouse operations and to drag the file. As the mouse pointer comes to the area of the display screen sharing client, the D&D detecting unit of the display screen sharing client detects the dragging of the file, and identifies the file path of the dragged file, followed by temporarily storing the file path in memory.

When the file is dropped on the shared display screen, the D&D detecting unit of the display screen sharing server of the information processing apparatus B 602 detects the dropping of the file so as to check the position where the file has been dropped. If a filer is situated at this position, the directory path of the filer is identified.

If the dropping has occurred on the desktop or on an application window other than a filer, the desktop is specified as a transfer destination, and its directory path is identified.

After the directory path is obtained, the information processing apparatus A 601 requests the information processing apparatus B 602 to transfer the file, and also informs the information processing apparatus B 602 of the obtained directory path. Upon receiving the request, the information processing apparatus B 602 starts transferring the file indicated by the file path temporarily stored in memory to the specified directory path in the information processing apparatus A 601.

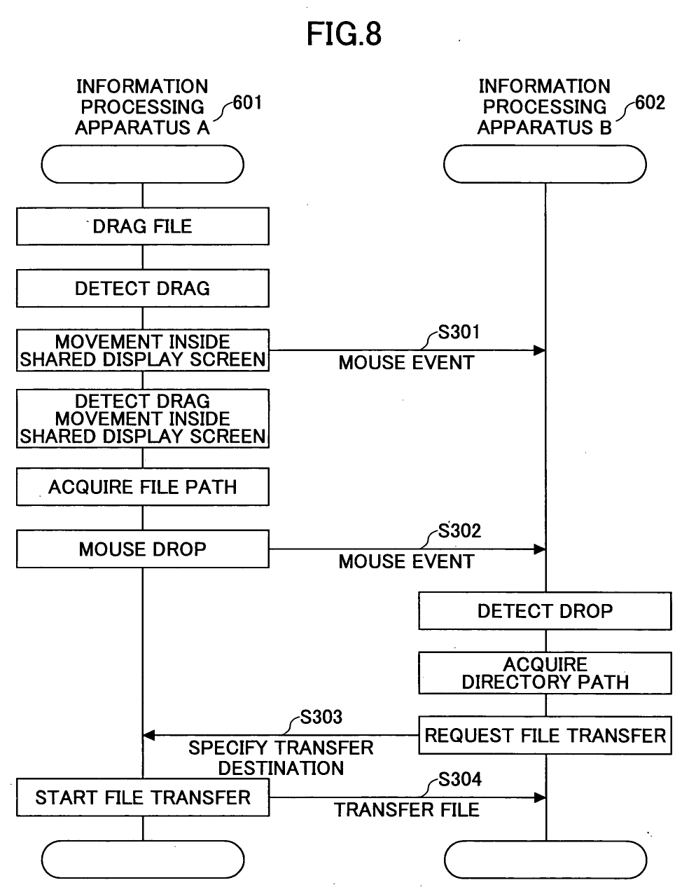

FIG. 8 is a sequence chart showing the interactions between the information processing apparatus A 601 and the information processing apparatus B 602. A file drag in the information processing apparatus A 601 is detected. At step S301, a movement inside the shared display screen is reported as a mouse event to the information processing apparatus B 602.

The information processing apparatus A 601 detects a drag movement inside the shared display screen, and identifies the file path. Upon detecting a file drop, the mouse event is reported to the information processing apparatus B 602 at step S302. In response, the information processing apparatus B 602 detects the drop, and then obtains the directory path. At step S303, the information processing apparatus B 602 requests file transfer with an indication of the transfer destination. At step S304, the information processing apparatus A 601 starts transferring the file.

### Embodiment 1

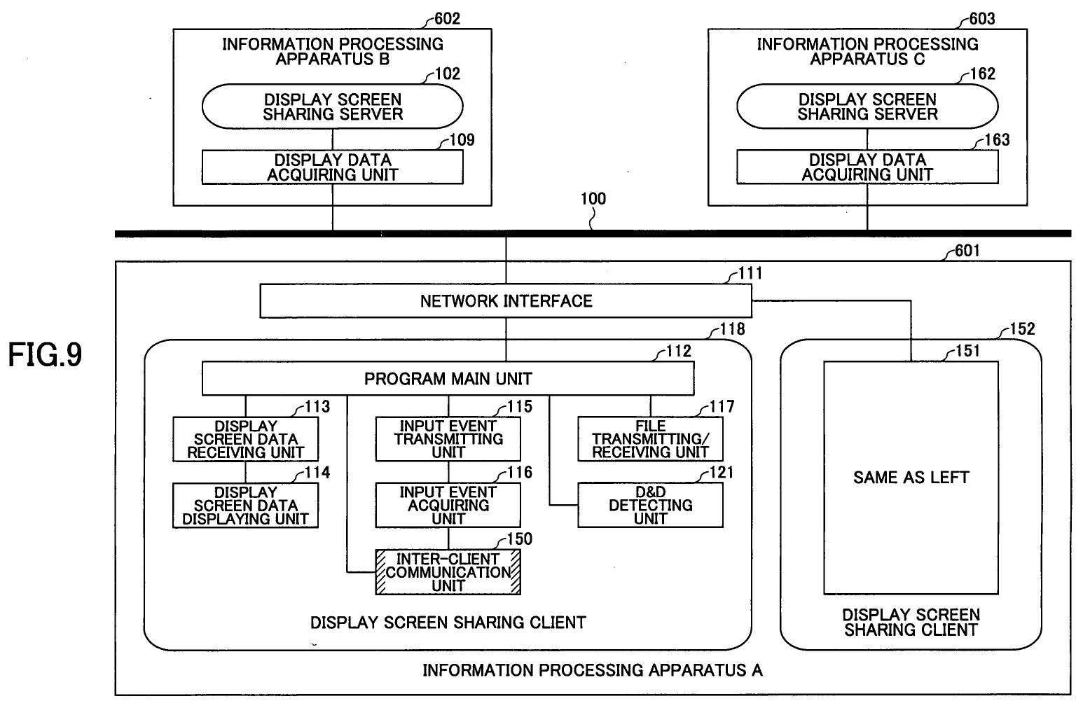

In the following, a description will be given of a case in which three information processing apparatuses are provided. FIG. 9 is a block diagram showing the configuration of a first embodiment of the display screen sharing system. In FIG. 9, an information processing apparatus C 603 is newly provided. As shown in FIG. 9, a display screen sharing server 162 operating based on the same principle as that of the information processing apparatus B 602 is running on the information processing apparatus C 603. A network interface 163 also operates in the same manner as that of the information processing apparatus B 602.

On the information processing apparatus A 601, two display screen sharing clients 118 and 152 are running. The display screen sharing client 152 has the same module set 151 as that of the display screen sharing client 118.

Each of the display screen sharing clients 118 and 152 is also provided with an inter-client communication unit 150. The inter-client communication unit 150 has the function to exchange data between a plurality of display screen sharing clients.

The display screen sharing client 118 is connected to the information processing apparatus B 602, and the display screen sharing client 152 is connected to the information processing apparatus C 603. Namely, the information processing apparatus A 601 displays the shared display screen of the information processing apparatus B 602 and the shared display screen of the information processing apparatus C 603.

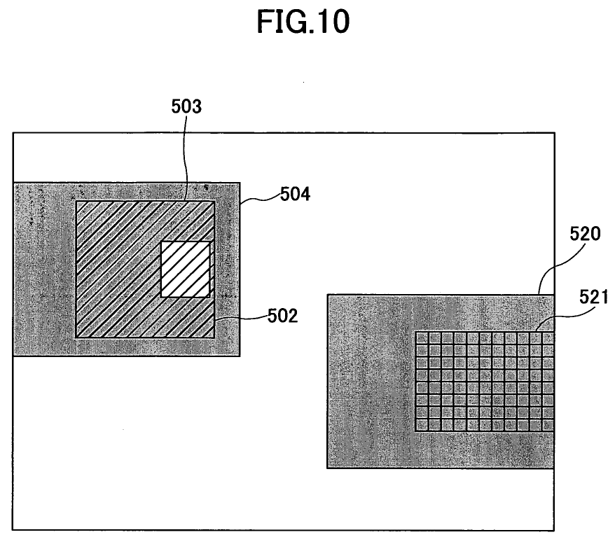

This provision makes it possible to achieve operations shown in FIG. 10. FIG. 10 is an illustrative drawing showing an example of a drag-&-drop operation. FIG. 10 shows the display screen of the information processing apparatus B 602, and a display screen 520 and a filer 521 of the information processing apparatus C 603.

The user can transfer a file by dragging and dropping the file 503 shown in the filer 502 of the information processing apparatus B 602 to the filer 521.

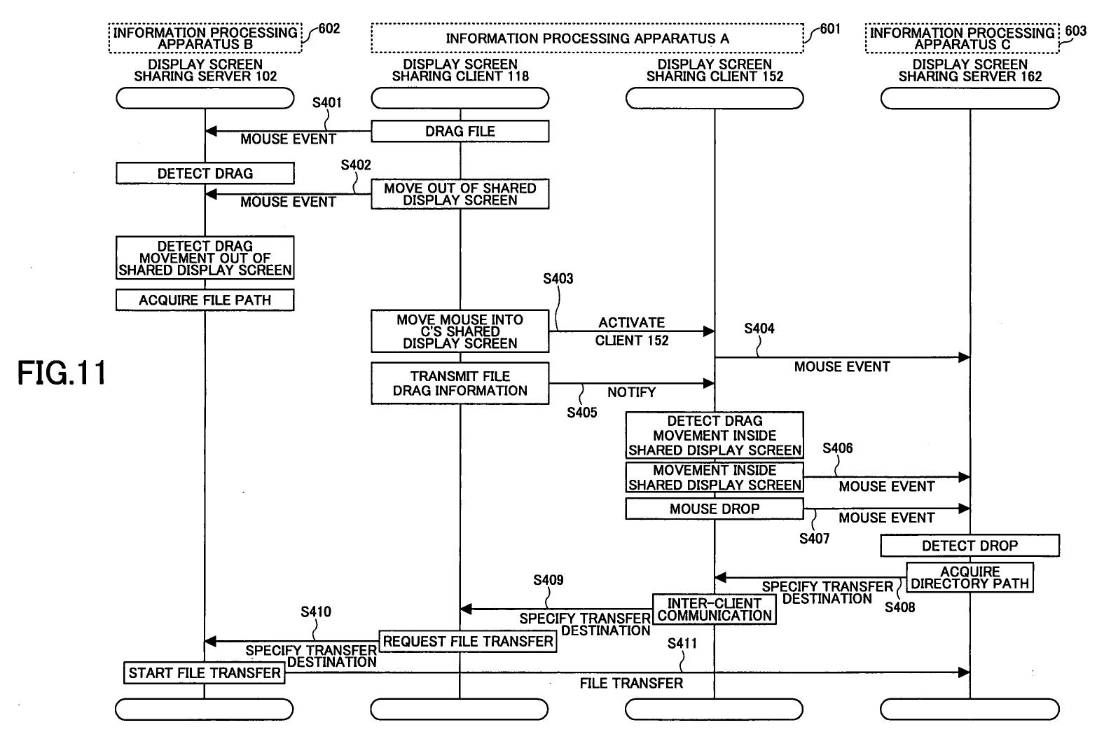

The process performed in this case will be described with reference to the sequence chart of FIG. 11. FIG. 11 is a sequence chart showing processes performed between the information processing apparatuses A 601, 602, and C 603.

At the information processing apparatus A 601, the user moves the mouse pointer to the window of the display screen sharing client 118 that displays the shared display screen of the information processing apparatus B 602. The user then selects and drags the file of the information processing apparatus B 602.

This drag is reported at step S401 as a mouse event to the information processing apparatus B 602. In response, the information processing apparatus B 602 detects the dragging of the file. As the user moves the mouse pointer out of the display screen sharing client 118 while dragging the file, this is reported as a mouse event at step S402. In response, the information processing apparatus B 602 detects that the mouse pointer dragging the file has moved out of the display screen sharing client 118, and identifies the file path of the file.

While dragging the file by the mouse of the information processing apparatus A 601, the user moves the mouse pointer into the window of the display screen sharing client 152 that displays the shared display screen of the information processing apparatus C 603. This event is reported at step S403 to the display screen sharing client 152. The window of the display screen sharing client 152 becomes an active window, starting to accept a mouse event.

As shown at step S404, a mouse event is now transmitted to the display screen sharing server 162 operating on the information processing apparatus C 603. Together with this, at step S405, the fact that the file of the information processing apparatus B 602 is being dragged is reported from the display screen sharing client 118 to the display screen sharing client 152.

The display screen sharing client 152 detects a drag movement inside the shared display screen. This is reported at step S406 as a mouse event to the display screen sharing server 162. The user then operates the mouse to release the mouse button to drop the file on the display screen sharing client 152. At step S407, this mouse event is transmitted to the display screen sharing server 162.

The display screen sharing server 162 obtains the directory path of the transfer destination. At step S408, the display screen sharing server 162 transmits the directory path to the display screen sharing client 152 to which the display screen sharing server 162 is connected. The display screen sharing client 152 knows that the dragged-and-dropped file is not a local file of the information processing apparatus A 601, but is a file of the display screen sharing server 102. The display screen sharing client 152 knows this because the relevant fact was reported at the time that the mouse pointer was moved into the display screen of the display screen sharing client 152. At step S409, thus, the display screen sharing client 152 informs the display screen sharing client 118 of the directory path of the transfer destination and the network address of the information processing apparatus C 603.

In response, at step S410, the display screen sharing client 118 transmits the directory path of the transfer destination and the network address of the destination information processing apparatus C 603 to the display screen sharing server 102, thereby requesting to transmit the file.

Upon receiving the request, the display screen sharing server 102 transmits the file specified by the file path to the specified directory of the information processing apparatus C 603 at step S411. This file path was obtained at the time that the event indicative of the dragging mouse pointer moving out of the display screen of the display screen sharing client 118 was detected. In this case, the display screen sharing server 102 transfers the file directly to the display screen sharing server 162 without using the information processing apparatus A 601 as an intermediary.

The detection of the dragging-&-dropping of a file may be performed properly by either a display screen sharing server or the display screen sharing client as long as the function of direct file transfer from the information processing apparatus B 602 to the information processing apparatus C 603 is achieved at the end. Further, as long as this function is achieved, the order of operations may as well be changed, and it does not matter in what order these operations are performed.

The transfer destination was determined by use of the operation flow shown in FIG. 5. Alternatively, provision may be made such that the desktop always serves as the destination regardless of where the file is dropped. Alternatively, the transfer destination to which a file is transferred may be fixed to a predetermined folder such as C: /Received.

Provision may be made such that a file is transferred from the information processing apparatus B 602 to a temporary folder in the information processing apparatus A 601, and is then transferred from the temporary folder of the information processing apparatus A 601 to the information processing apparatus C 603, followed by deleting the file from the temporary folder of the information processing apparatus A 601. In this case, however, the time required for transfer increases. Provision may be made such that if it is ascertained that direct communication cannot be made between the information processing apparatus B 602 and the information processing apparatus C 603, the file is transferred by using the information processing apparatus A 601 as an intermediary.

### Embodiment 2

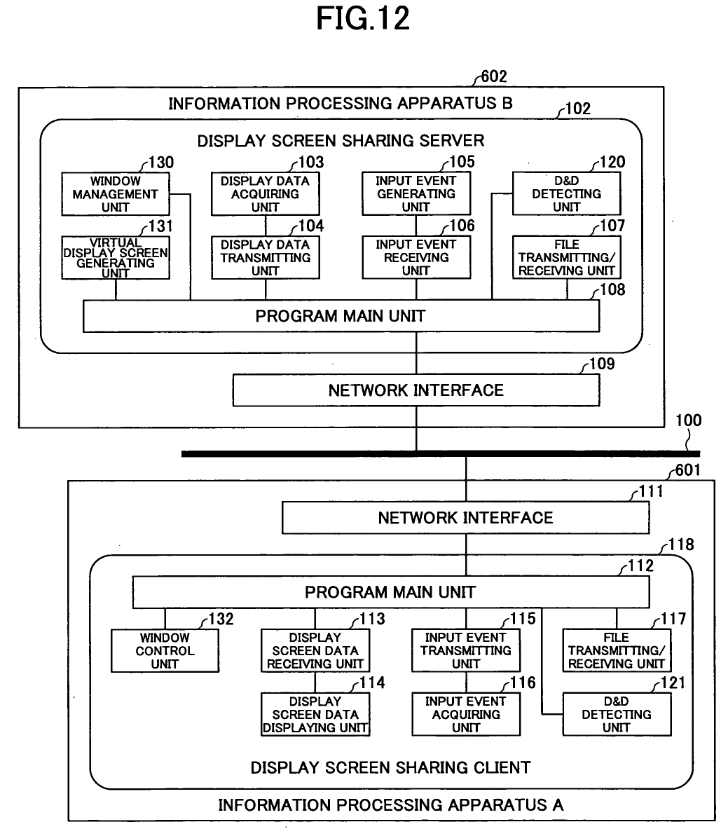

In the following, a description will be given of an embodiment in which the configuration shown in FIG. 3 is provided with an additional function. FIG. 12 is a block diagram showing a configuration in which the display screen sharing server includes a window management unit 130 and a virtual display screen generating unit 131 as additional units, and the display screen sharing client 118 includes a window control unit 132 as an additional unit.

The virtual display screen generating unit 131 generates a virtual desktop display screen separately from a real desktop display screen that is displayed on the display device of the information processing apparatus. Namely, the virtual display screen generating unit 131 serves as a virtual video driver that makes it appear to the OS that a second display device is connected.

The window management unit 130 acquires the window handle of a predetermined window, and stores the window handle as the display identifier. The window control unit 132 displays a window having the same size and position as the shared display screen as it appear on the virtual desktop display screen of the shared display screen server.

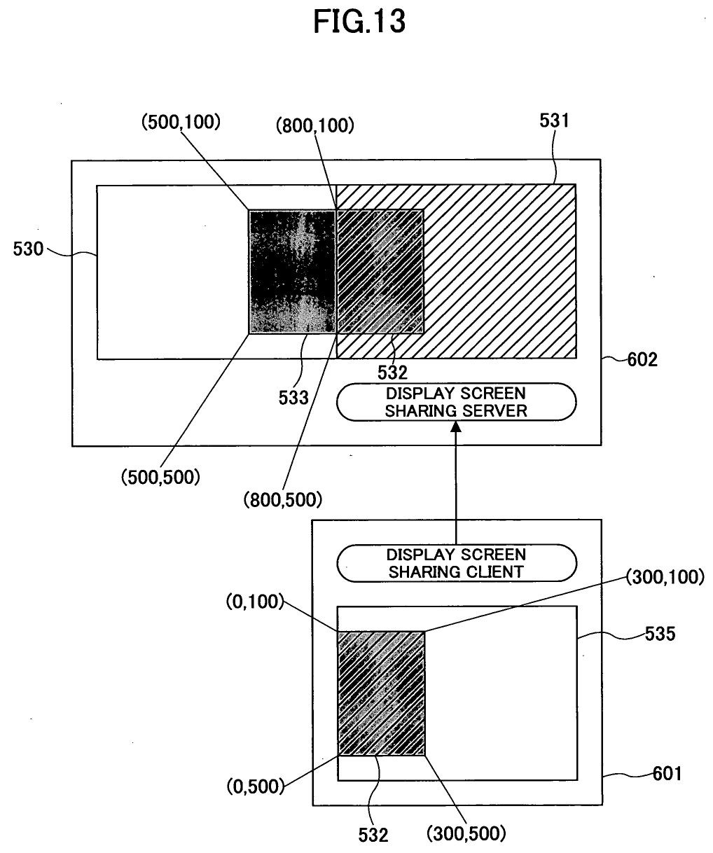

The display screen of the above-described configuration will be described with reference to FIG. 13. FIG. 13 is an illustrative drawing showing operations on the display according to the second embodiment, and shows the information processing apparatus B 602 and the information processing apparatus A 601. In FIG. 13, (*, *) indicates coordinates.

A display screen 530 is the display screen of the information processing apparatus B 602. The display screen 530 corresponds to the entirety of the display screen of the information processing apparatus B 602. A window 533 is the window of an application that is displayed on the display screen 530.

A display screen 531 that is shown on the right side of the display screen 530 is a virtual desktop display screen. The window 533 extends over to the display screen 531. The portion to which the window 533 extends over is a shared display screen 532. The shared display screen 532 constitutes a shared display screen display area.

A display screen 535 of the information processing apparatus A 601 shows a portion of the window 533 that extends beyond the boundary.

With this configuration, it is possible to achieve an action as if a document was slid over from one's desk to the next person's desk atop the surfaces of these desks.

In the above example, the right edge of the display screen 530 of the information processing apparatus B 602 constitutes the border with the virtual desk top.

With the configuration shown in FIG. 12, the information processing apparatus B 602 operates such that only the display screen of the window displayed on the virtual desktop display screen is shared. At the information processing apparatus A 601, the window displayed on the virtual desktop display screen is shown as a shared display screen having the same position and size as it appears on the virtual desktop display screen of the server.

If the size of the display screen of the information processing apparatus A 601 is identical to that of the information processing apparatus B 602, the background portion of the virtual desktop is not shown on the display screen of the information processing apparatus B 602, and the display screen without the background portion is shown in such a manner as to fit the desktop of the information processing apparatus A 601.

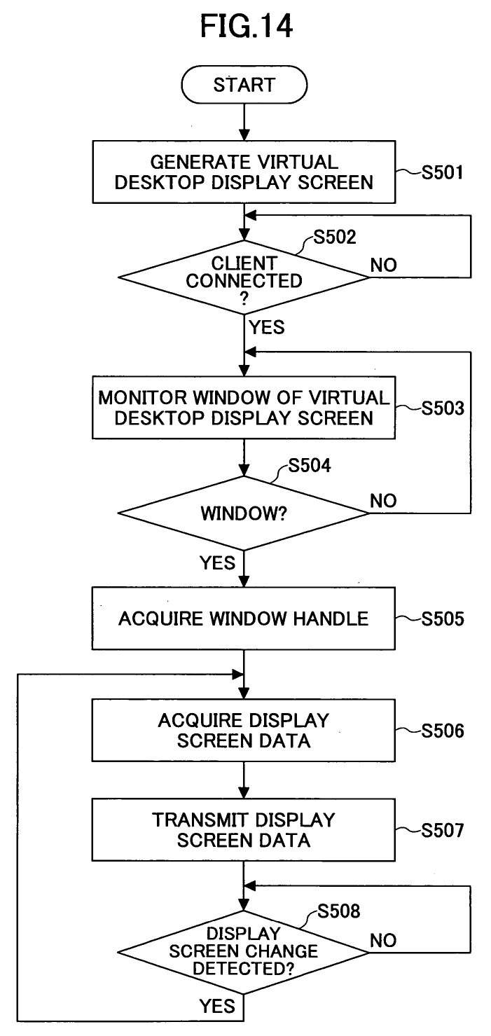

With respect to the operations described above, the process of the display screen sharing server 102 provided in the information processing apparatus B 602 will be described with reference to FIG. 14. FIG. 14 is a flowchart showing the process of the display screen sharing server according to the second embodiment.

As the display screen sharing server is activated, the display screen sharing server generates a virtual desktop display screen at step S501. At step S502, the display screen sharing server waits for a connection with a client. When a client is connected, the display screen sharing server 102 monitors at step S503 whether a window is displayed on the virtual desktop. If it is ascertained at step S504 that a window is displayed on the virtual desktop, the procedure proceeds to step S505.

At step S505, the window management unit 130 of the display screen sharing server 102 obtains the window handle of the window, and stores the window handle as the display screen identifier. At step S506, image data of the portion of the window that is displayed on the virtual desktop display screen is acquired. At step S507, the image data is transmitted to the display screen sharing client 118. Here, the image data of the virtual desktop itself is not captured. At step S508, it is monitored whether a new change occurs in the display screen. If a display screen update is detected, the image data is acquired, and is transmitted to the client, which is repeated many times over.

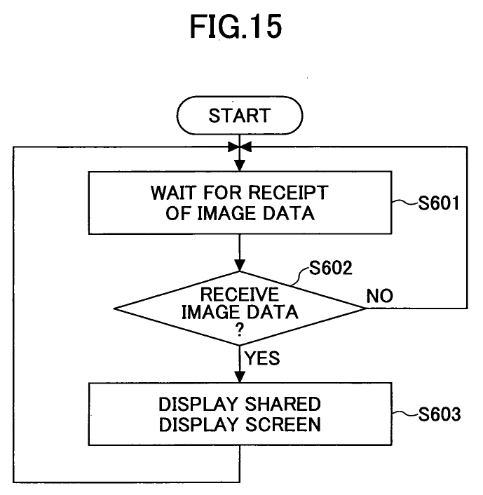

In the following, a description will be given of the basic operation of the display screen sharing client 118 provided in the information processing apparatus A 601 with reference to FIG. 15. FIG. 15 is a flowchart of the process of the display screen sharing client according to the second embodiment. The display screen sharing client does not display anything when no window is displayed on the virtual desktop display screen of the display screen sharing server during connection with the display screen sharing server. As shown in step S601, the display screen sharing client is placed in the state of waiting for image data supplied from the display screen sharing server.

As a window is displayed on the virtual desktop display screen of the display screen sharing server, the display screen sharing server transmits image data. At step S602, the display screen sharing client receives the image data. The display screen sharing client displays a shared display screen on the display screen of the display screen sharing client at step S603 based on the image data received from the display screen sharing server. In so doing, the window control unit of the display screen sharing client displays the window as having the same position and size as the shared display screen appears on the virtual desktop display screen of the display screen sharing server.

The above description has been given by focusing on the displaying of the display screen among the operations relating to display screen sharing. In the following, a description will be given of a process performed when the display screen sharing client on the information processing apparatus A 601 performs the remote control of a shared display screen. Such remote control involves changing the position and size of a window, and also involves other operations. Those other operations will be described first.

The display screen sharing server receives an input event from the display screen sharing client, and generates the input event locally. This allows the information processing apparatus A 601 having the client running thereon to control the information processing apparatus B 602 having the server running thereon.

If the information processing apparatus A 601 performs an operation that is not the changing of the position and/or size of a window with respect to the shared display screen shared with the information processing apparatus B 602, subsequent operations are the same as those performed by conventional display screen sharing software. Namely, when the information processing apparatus A 601 serving as a client receives an input event from the inputting device such as a keyboard and/or mouse while the shared display screen is in an active state, the input data is transmitted to the display screen sharing server.

In the following, a description will be given of a process performed when the position and/or size of a window is changed.

Conventional display screen sharing software can freely change the position of the display screen sharing client and the size of the window. In this embodiment, the window control unit of the display screen sharing client controls the position and size of the window.

As previously described, if the size (i.e., resolution) of the display screen of the information processing apparatus A 601 is the same as that of the information processing apparatus B 602, the background portion of the virtual desktop is not shown on the display screen of the information processing apparatus B 602, and the display screen without the background portion is shown in such a manner as to fit the desktop of the information processing apparatus A 601.

A description will be given of an example in which the resolution of the display screen of the information processing apparatuses A 601 and 602 is SVGA (800×600 pixels). The display screen sharing server sets the resolution of the virtual desktop display screen to SVGA that is the same as the real desktop of the information processing apparatus B 602.

It is assumed that an application A running on the real desktop of the information processing apparatus B 602 has a display screen size of 600×400.

Under the conditions as described above, the user of the information processing apparatus B 602 operates the information processing apparatus B 602 to move the window of an application across the border between the desktops, such that the window is also shown in the virtual desktop display screen.

For example, as shown in FIG. 13, half of the application window may be displayed in the virtual desktop display screen. In this case, the real desktop of the information processing apparatus B 602 shows a 300-×-400 area defined by the four corner points (500, 100), (800, 100), (500, 500), and (800, 500), which are absolute coordinates in reference to the origin at the top left corner of the display screen. The remaining portion is displayed in the virtual display screen.

In the virtual desktop display screen, a 300-×-400 area is shown as defined by the four corner points (0, 100), (300, 100), (0, 500), and (300, 500), which are absolute coordinates in reference to the origin at the top left corner of the virtual desktop display screen.

Accordingly, the display screen sharing server shares the display screen of the latter 300-×-400 area. On the real desktop display screen of the information processing apparatus A 601, the shared display screen is shown as a 300-×-400 area defined by the four corner points (0, 100), (300, 100), (0, 500), and (300, 500), which are absolute coordinates in reference to the origin at the top left corner of the display screen of the information processing apparatus B 602. This is the same as the virtual desktop display screen of the information processing apparatus B 602.

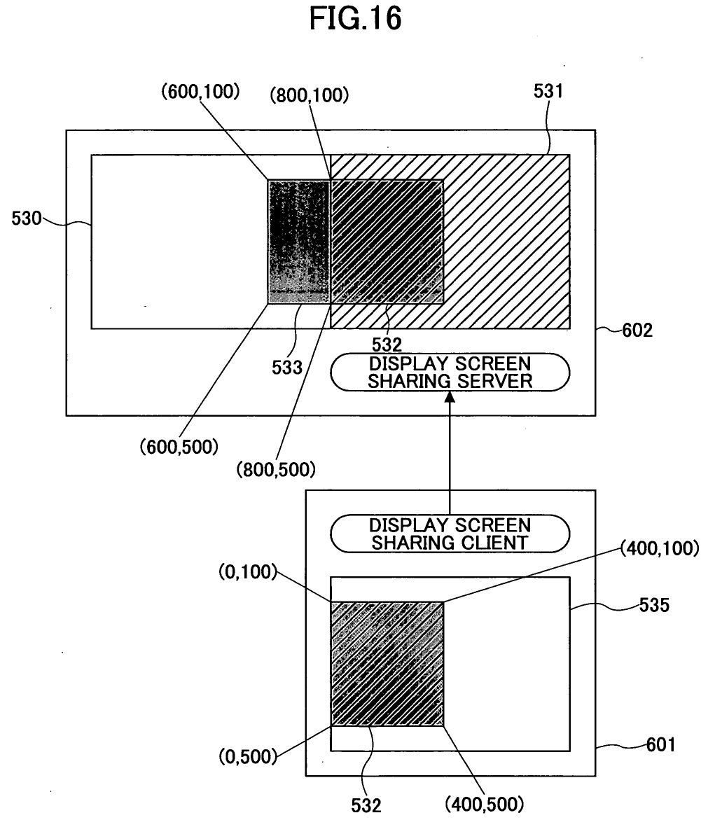

A description will be given of an operation by which the window of the application A is shifted 100 pixels to the left as shown in FIG. 16 from its position shown in FIG. 13. FIG. 16 is an illustrative drawing showing an example of a display screen in which a window is shifted according to the second embodiment.

On the real desktop of the information processing apparatus B 602, a 200-×-400 area is shown as defined by the four corner points (600, 100), (800, 100), (600, 500), and (800, 500), which are absolute coordinates in reference to the origin at the top left corner of the display screen. On the virtual desktop display screen of the information processing apparatus B 602, a 400-×-400 area is shown as defined by the four corner points (0, 100), (400, 100), (0, 500), and (400, 500), which are absolute coordinates in reference to the origin at the top left corner of the display screen.

On the real desktop of the information processing apparatus A 601, the shared display screen is shown as a 400-×-400 area defined by the four corner points (0, 100), (400, 100), (0, 500), and (400, 500), which are absolute coordinates in reference to the origin at the top left corner of the display screen.

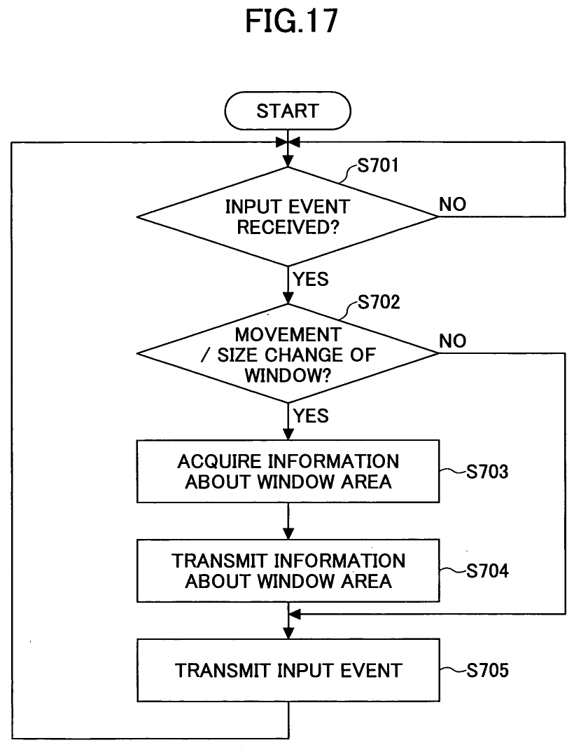

FIG. 17 is a flowchart showing a process performed when the window of an application is moved by operating the information processing apparatus B 602 (display screen sharing server).

At step S701, the display screen sharing server checks whether there is an input event. If an input event is received, a check is made at step S702 as to whether the position and/or size of the window are changed. If the position and/or size of the window are not changed, the procedure proceeds to step S705.

If the position and/or size of the window are changed, the display screen sharing server acquires information about the window area at step S703. At step S704, the window area information is transmitted. At step S705, the input event is transmitted, followed by returning to step S701.

In the information processing apparatus A 601, the window control unit of the display screen sharing client displays the received display screen data while displaying a window as having the same position and size as the shared display screen appears on the virtual desktop display screen of the display screen sharing server. That is, a 400-×-400 area is displayed as defined by the four corner points (0, 100), (400, 100), (0, 500), and (400, 500), which are absolute coordinates in reference to the origin at the top left corner of the display screen.

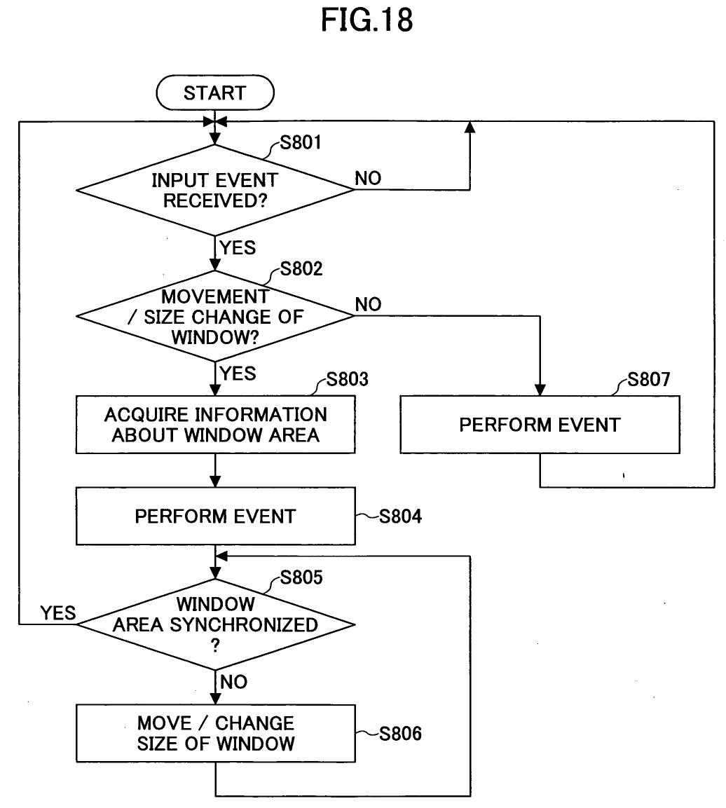

FIG. 18 is a flowchart of a process performed when the shared display screen is moved by operating the information processing apparatus A 601.

At step S801, a check is made as to whether an input event is received. If an input event is received, a check is made at step S802 as to whether the position and/or size of the window are changed. If the position and/or size of the window are not changed, an event is performed at step S807, and, then, the procedure returns to step S801.

If the position and/or size of the window are changed, information about the window area is acquired at step S803. At step S804, an event is performed.

At step S805, a check is made as to whether the window area is in synchronization. If the window area is in synchronization, the procedure returns to step S801. If the window area is not in synchronization, the position and/or size of the window are changed at step S806, following by returning to step S805.

In this process, the window control unit of the display screen sharing client transmits the information about the display area of the window such that the absolute-coordinate-based display area of the shared display screen window on the information processing apparatus B 602 is synchronized with the absolute-coordinate-based display area of the application A on the virtual desktop display screen of the information processing apparatus A 601.

In the example of FIG. 16, the fact that the 400-×-400 area is displayed as defined by the four corner points (0, 100), (400, 100), (0, 500), and (400, 500), which are absolute coordinates in reference to the origin at the top left corner of the display screen, is reported to the display screen sharing server.

Upon receiving this information, the display screen sharing server moves the window such that the window of the application is displayed on the virtual desktop display screen as specified by the client.

Through these operations, no matter which one of the display screen sharing client and the display screen sharing server moves the shared window of the application, the shared display screen of the information processing apparatus A 601 appears exactly the same as the window of the application shown on the virtual desktop of the information processing apparatus B 602. This is achieved by a mechanism that displays the images at the same synchronized position in terms of absolute coordinates.

A change in the size of the display screen can also be achieved by use of the same flow.

In the following, a description will be given of operations performed when the entirety of the window of a shared application is shared as a shared display screen.

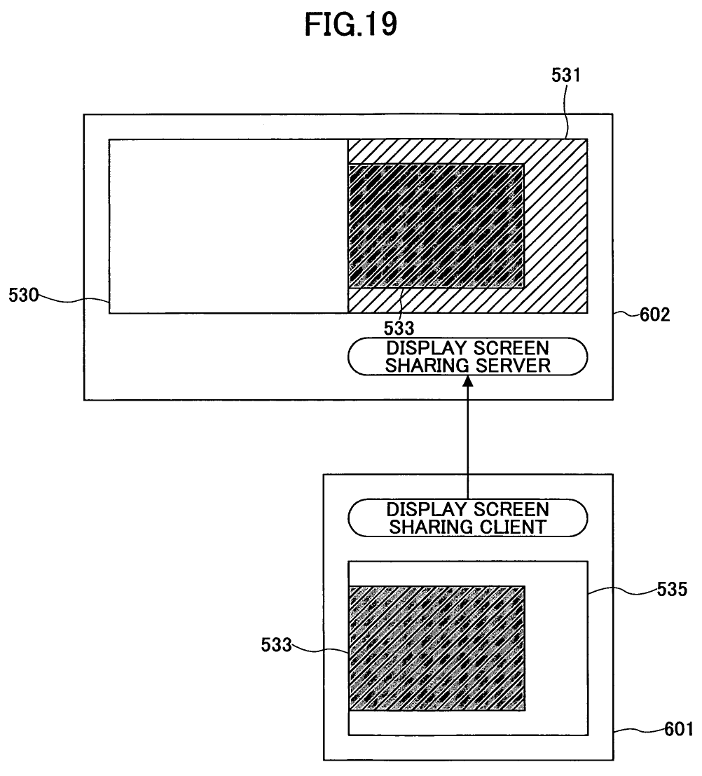

A description will be give of an example in which the information processing apparatus B 602 is operated to move the window 533 of a shared application such that the entirety of the window 533 is shown within the display screen 531 of the virtual desktop as shown in FIG. 19.

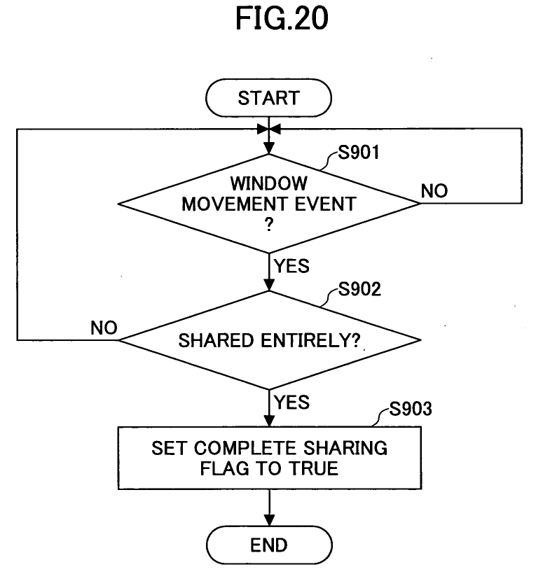

As the application window 533 is moved entirely to the display screen 531 of the virtual desktop, it may not be possible to move the window 533 by operating the mouse of the information processing apparatus B 602. (Although it is not entirely impossible, the display screen is not shown, so that handling becomes difficult). A method of moving the window 533 will be described with reference to a flowchart of FIG. 20.

FIG. 20 is a flowchart of a process performed by the window management unit of the display screen sharing server according to the second embodiment.

The window management unit of the display screen sharing server monitors a window for which a display screen is shared. The window of an application is monitored. By monitoring an event regarding the movement of window position, the window management unit detects the movement of the window at step S901.

If a window movement event is detected, a check is made at step S902 as to whether the window of the application is moved entirely into the display screen of the virtual desktop. Namely, the coordinates of the top left corner of the application window is monitored. If the coordinates of the top left corner correspond to a point inside the real desk top, the procedure goes back to step S901, and the monitoring continues.

When it is detected that the top left corner has moved to the virtual desktop display screen, it is ascertained the application now has its entirety (i.e., its entire area) shared with the display screen sharing client. The window management data of this application includes a complete sharing flag to indicate whether complete sharing is achieved. This complete sharing flag is set to TRUE at step S903. As this flag is set to TRUE, the sharing of this application by operating the information processing apparatus B 602 can be prohibited.

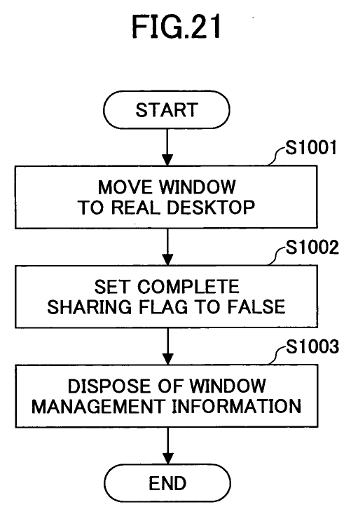

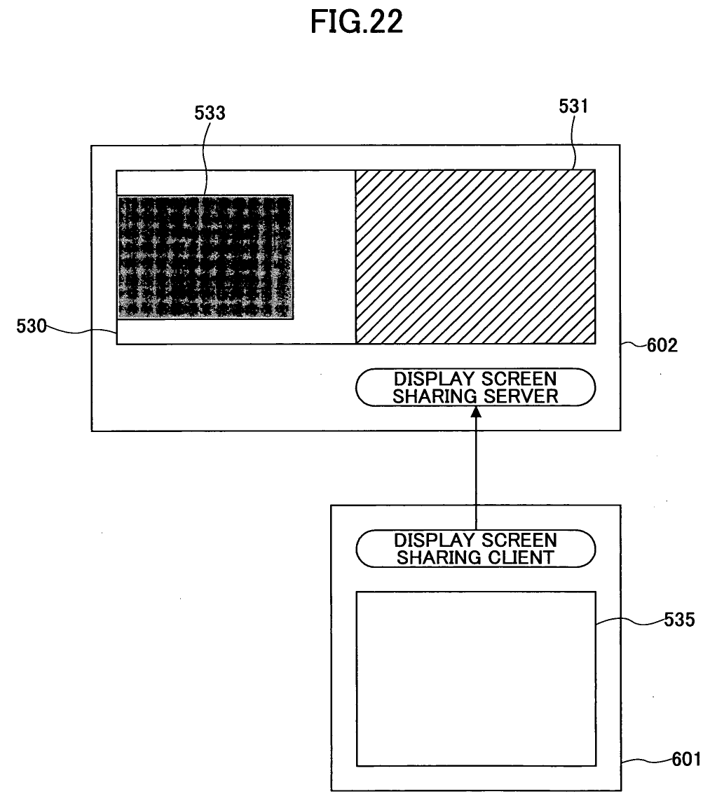

In the following, the flowchart of FIG. 21 and FIG. 22 will be used to describe a method of disabling the sharing of an icon that is displayed on the system tray.

The display screen sharing server includes a means for registering an icon for the system tray on the desktop. When an icon displayed on the system tray receives a mouse click event, a menu for operation of the display screen sharing server will be displayed.

The window management unit of the display screen sharing server has the function to add a menu item for disable the sharing of a currently shared window to the menu that is displayed in response to a click on the icon of the display screen sharing server.

The user operates the information processing apparatus B 602 to select the menu. In response, the display screen sharing server stops sharing the display screen of the application.

When the user operates the information processing apparatus B 602 to disable the sharing of the application, the window management unit of the display screen sharing server moves the window corresponding to the stored window handle of the application at step S1001 such that the window is positioned on the real desktop as shown in FIG. 22.

The shift amount corresponds to the resolution in the horizontal direction of the display screen. In this embodiment, the resolution of the desktop is 800×600. Accordingly, the window is moved to the right by 800 pixels.

Since the complete sharing has come to an end, at step S1002, the complete sharing flag is set to FALSE. Further, since the display screen sharing of the application has come to an end, the information regarding the application stored by the window management unit 130 is discarded at step S1003.

The discarding of the information involves deleting from the system tray menu a menu item for disabling the sharing of the application.

When the information processing apparatus B 602 stops the display screen sharing server, the display screen sharing server performs a terminating process. In this terminating process, the display screen sharing server moves all the shared windows to the real desktop display screen and disposes of the virtual desktop display screen according to the flow shown in FIG. 21.

In the following, a description will be given of a method of disabling the sharing of a display screen by operating the display screen sharing client. This method can be performed when a portion of the application A is subjected to display screen sharing as shown in FIG. 13 or FIG. 16, or when the application A is entirely shared as shown in FIG. 22, whichever the case may be.

Like the display screen sharing server, the display screen sharing client also has a means for registering an icon for the system tray on the desktop. When an icon displayed on the system tray receives a mouse click event, a menu for operation of the display screen sharing client will be displayed.

The display screen sharing client has the function to add a menu item for disable the sharing of a currently shared window to the menu that is displayed in response to a click on the icon of the display screen sharing client.

The user operates the information processing apparatus A 601 to select the disabling of application sharing. In response, the display screen sharing client transmits an event indicative of the disabling of display screen sharing to the display screen sharing server. Upon receiving this event, the display screen sharing server performs the flow shown in FIG. 21, thereby moving the window in the same manner as was described above, so as to disable the sharing of the display screen.

When the information processing apparatus A 601 stops the execution of the program of the display screen sharing client, or when the connection with the display screen sharing server of the information processing apparatus B 602 is disconnected, an event indicative of the disabling of the sharing of all the shared windows is transmitted to the display screen sharing server. After this, the connection is disconnected.

In the following, a description will be given of a method of performing and disabling complete sharing from the display screen sharing client. As was previously described, owing to the operation of the window control unit of the display screen sharing client, the shared display screen of the information processing apparatus B 602 is synchronized with the display position of the application window on the virtual desktop display screen of the information processing apparatus A 601.

From the position shown in FIG. 16, the user of the information processing apparatus A 601 drags a toolbar of the window of the shared display screen by use of a mouse, thereby moving the window to the display screen 535 shown in FIG. 19. As a result, the application window is shared in its entirety as shown in the display screen 531 of FIG. 19.

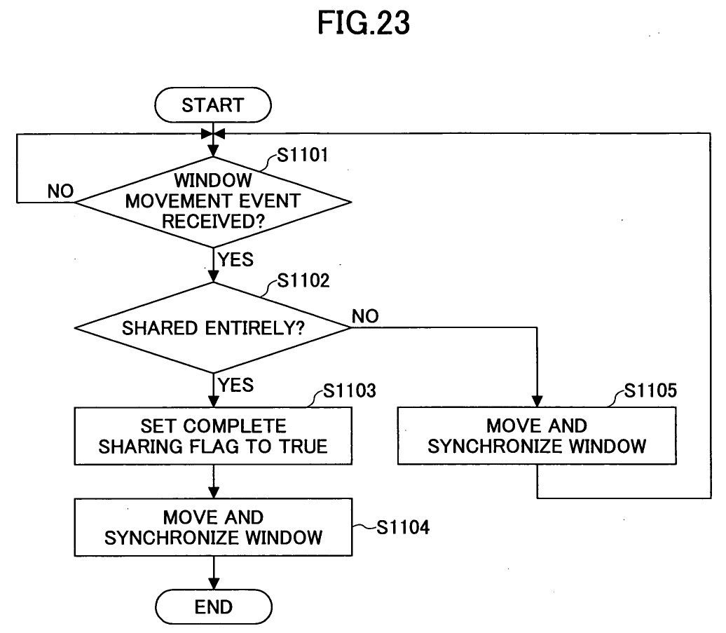

FIG. 23 is a flowchart of a process performed by the window management unit of the display screen sharing server according to the second embodiment. This process is performed when the display screen sharing client moves the shared display screen to achieve complete sharing.

The window management unit of the display screen sharing server monitors whether the window is in the state of being entirely shared, as described in connection with FIG. 20. This monitoring is performed with respect to a window movement event supplied from the display screen sharing client.

It should be noted that the monitoring is performed by checking the display area data of the shared display screen supplied from the window control unit of the client.

At step S1101, a window movement event is detected. At step S1102, a check is made as to whether the window is shared in its entirety. If it is ascertained at step S1102 that the window is shared in its entirety, the complete sharing flag as described above is set to TRUE at step S1103. At step S1104, the window is moved to the position indicated by the client such as to achieve synchronization. The operation to synchronize the window positions is the same as what was described in connection with FIG. 18, and a description thereof is omitted. If the movement of the window does not result in complete sharing, the complete sharing flag remains FALSE, and the window is synchronized at step S1105 in the same manner as in FIG. 18.

With the configuration as described above, the information processing apparatus B 602 having the display screen sharing server running thereon is operated by use of its mouse to move an application window having a portion that is displayed as a shared display screen on the information processing apparatus A 601 having the display screen sharing client running thereon, such that the window is placed on the desktop of the information processing apparatus B 602. The window of the application on the information processing apparatus A 601 is also moved in synchronization. As a result, it is possible to achieve the sharing of a display screen with respect to the entirety of the application window on the information processing apparatus B 602.

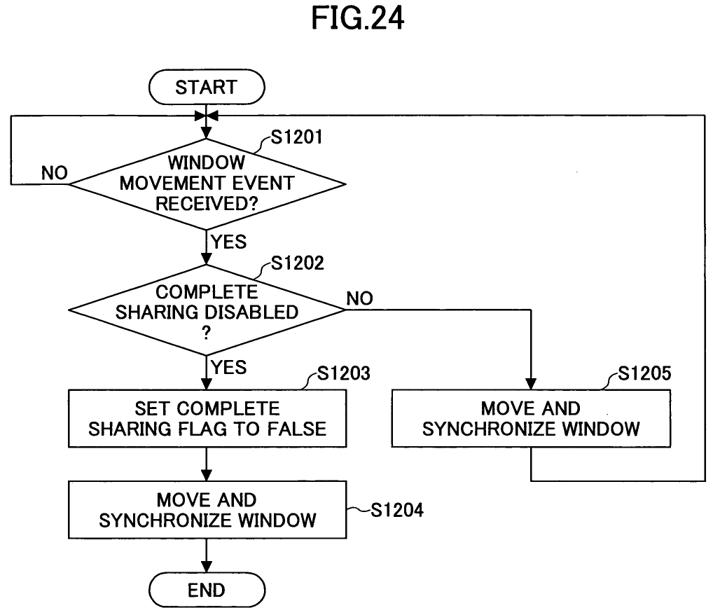

In the following, a description will be given of operations performed by the display screen sharing server when complete sharing is disabled through window operations performed at the display screen sharing client. FIG. 24 is a flowchart of a process performed by the window management unit of the display screen sharing server according to the second embodiment.

The window management unit of the display screen sharing server monitors whether the window is in the state of being entirely shared, as described in connection with FIG. 21. This monitoring is performed with respect to a window movement event supplied from the display screen sharing client. It should be noted that the monitoring is performed by checking the display area data of the shared display screen supplied from the window control unit of the client.

At step S1201, a window movement event indicative of the disabling of complete sharing of the application is detected. If it is ascertained at step S1202 that complete sharing is disabled, the complete sharing flag is set to FALSE at step S1203. At step S1204, the window is moved to the position indicted by the client such as to achieve synchronization. The operation to synchronize the window positions is the same as what was described in connection with FIG. 18. If the movement of the window does not result in complete sharing, the complete sharing flag remains FALSE, and the window is synchronized at step S1205 in the same manner as in FIG. 14.

With the configuration as described above, with the display screen of an application of the information processing apparatus B 602 being completely shared, the user operates the mouse of the information processing apparatus B 602 to move the window of the shared display screen (to the left) from the virtual desktop display screen to the real desktop display screen at the information processing apparatus B 602.

The window of the application on the information processing apparatus A 601 is also moved in synchronization. In this manner, the application window is moved to such a position that the window is also displayed on the real desktop, which results in the complete sharing being disabled, thereby making it possible to use the mouse of the information processing apparatus B 602 to control the application A.

In the example described above, when the application is moved to the virtual desktop display screen such that the application is entirely shared with the client, it becomes impossible to operate the window while viewing the display screen of the application at the information processing apparatus A 601. In the following, a method that obviates this problem will be described. Further, a description will be given of method that makes it possible to operate the application A at the information processing apparatus B 602 on which the display screen sharing server is running.

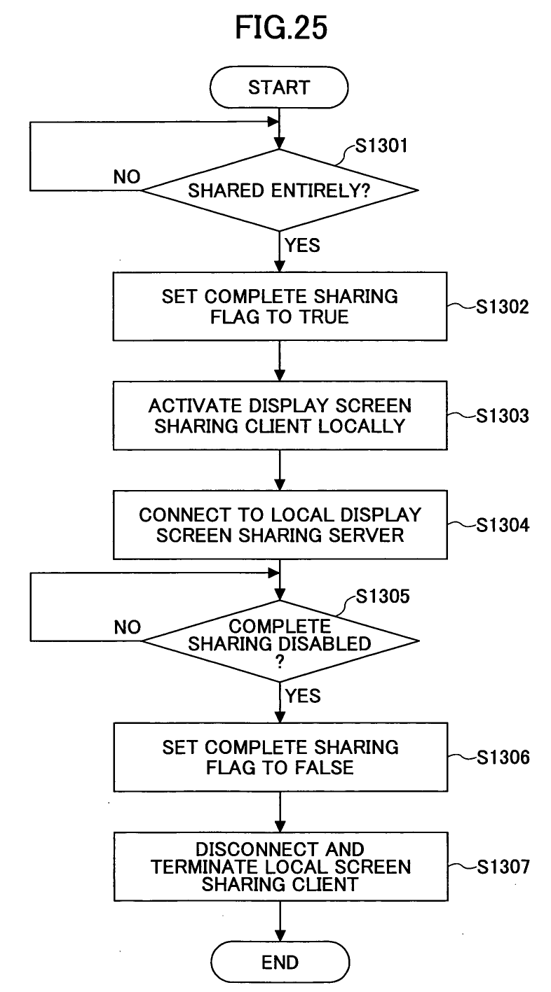

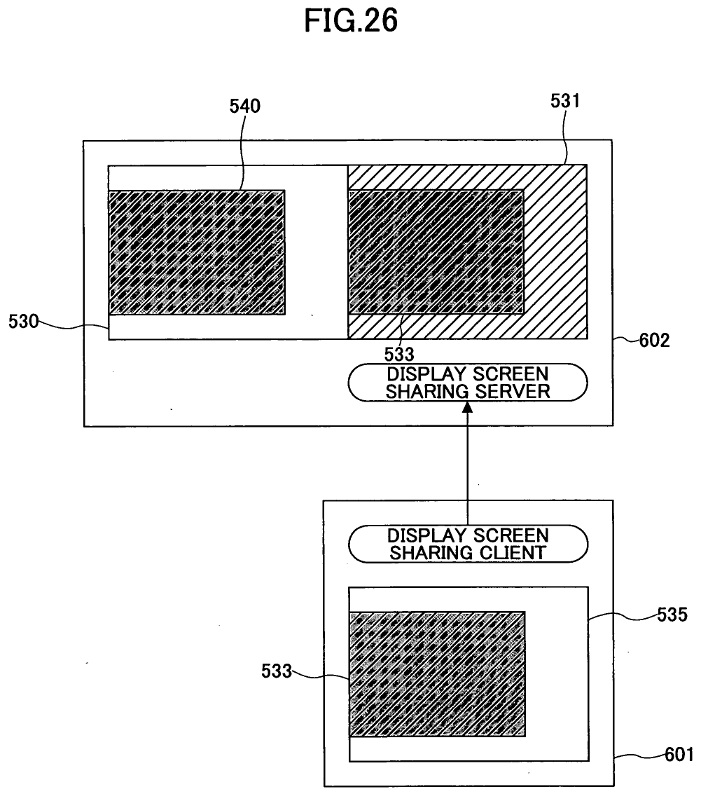

FIG. 25 is a flowchart of the operation of the display screen sharing server of the second embodiment. FIG. 26 is an illustrative drawing for explaining the display screen of the second embodiment. At step S1301, the window management unit of the display screen sharing server monitors whether the display screen of a shared application window is shared in its entirety. If it is detected that the display screen is shared entirely with the client, the complete sharing flag is set to TRUE at step S1302. At step S1303, the display screen sharing server activates the display screen sharing client locally at the information processing apparatus B 602 on which the display screen sharing server is running, and displays the display screen sharing client on the real desktop display screen. What is displayed in this manner is a local display screen 540 shown on the display screen 530 as illustrated in FIG. 26.

In so doing, the window of the display screen sharing client is displayed in its entirety on the real desktop, and is not displayed on the virtual desktop display screen. The activated display screen sharing client is connected to the display screen sharing server at step S1304.

In the same manner as the display screen sharing client running on the information processing apparatus A 601, the display screen sharing client locally activated is subjected to synchronization with respect to the display area of a window by the window control unit.

Namely, the display screen sharing client is displayed on the real desktop display screen of the information processing apparatus B 602 as having the same position and size as the application appears on the virtual desktop display screen of the information processing apparatus B 602.

If it is detected at step S1305 that complete sharing is disabled, the complete sharing flag is set to FALSE at step S1306. At step S1307, the display screen sharing server instructs to disconnect and terminate the local display screen sharing client. With the display screen sharing client being terminated, display screen sharing returns to its normal state.

If the sharing of a display screen is terminated by the display screen sharing server or by the information processing apparatus on the display screen sharing client side, the display screen sharing server performs a program terminating process that returns the application window to the real desktop, followed by terminating the program.

In the following, the transfer of a file with the shared display screen will be described. When a file on the information processing apparatus A 601 is transferred to the information processing apparatus B 602 by performing a drag-&-drop operation with respect to the shared display screen, there may be a case in which a file on the information processing apparatus B 602 displayed on the shared display screen is dragged and dropped locally to the information processing apparatus B 602. This is achieved by adding, to the display screen sharing system described with respect to the present embodiment, the file transfer function based on the drag-&-drop operation as described in connection with FIG. 6 and FIG. 8.

As a variation, a function may be provided that disables the operation of the window control unit of the display screen sharing client, thereby allowing the position and/or size of the shared display screen to be freely changed on the desktop of the display screen sharing client. In this case, its operation becomes close to that of the conventional display screen sharing client software.

Further, provision may be made such that when the entirety of a display screen area is shared, the operation of the window control unit of the client is automatically disabled. This allows the position and/or size of the shared display screen to be freely changed on the desktop of the client.

When the windows of two or more applications are shared, the window management unit of the display screen sharing server acquires a window handle separately for each of the windows for the management purposes.

When two or more windows are shared, the display screen sharing server may need to disable the sharing. In such a case, the list of window titles for which sharing may be disabled is presented to the user, and all the windows or the windows selected by the user may be subjected to the disabling of window sharing.

The window management unit of the display screen sharing server disposes of management information on applications if these applications having their display screens shared are terminated or come to an end.

In order to prevent the complete sharing of a window, the window management unit of the display screen sharing server may monitor the display area of the shared application window. If an instruction to move the entirety of the window to the virtual desktop display screen is detected, such instruction may be disregarded by an additionally provided function. Alternatively, an alarm may be issued by generating a beeping sound or by display a dialog box. Monitoring can be performed by checking a received event regarding window movement supplied from the display screen sharing client or by hooking a window movement event of the display screen sharing server (i.e., the information processing apparatus B 602).

There may be a need to disable the sharing of a display screen that is entirely shared at the information processing apparatus B 602 on which the display screen sharing server is running. In such a case, rather than moving the window to the left by a distance corresponding to the resolution of the display screen, the window may be moved based on its calculated display position, such that the window is displayed at the center of the display screen of the real desktop of the information processing apparatus B 602 (i.e., such that the center point of the application window matches the center point of the real desktop display screen).

When a plurality of display screen sharing clients are connected to a single display screen sharing server, one of the display screen sharing clients may be disconnected while other display screen sharing clients remain connected. In such a case, functionality is provided to avoid the disabling of window sharing with respect to the windows of these other display screen sharing clients.

### Embodiment 3

In the following, a description will be given of another embodiment that obviates a problem that, when an application is moved to the virtual desktop display screen for complete sharing by the client, it becomes impossible to operate the application by viewing the display screen of the application at the information processing apparatus A 601.

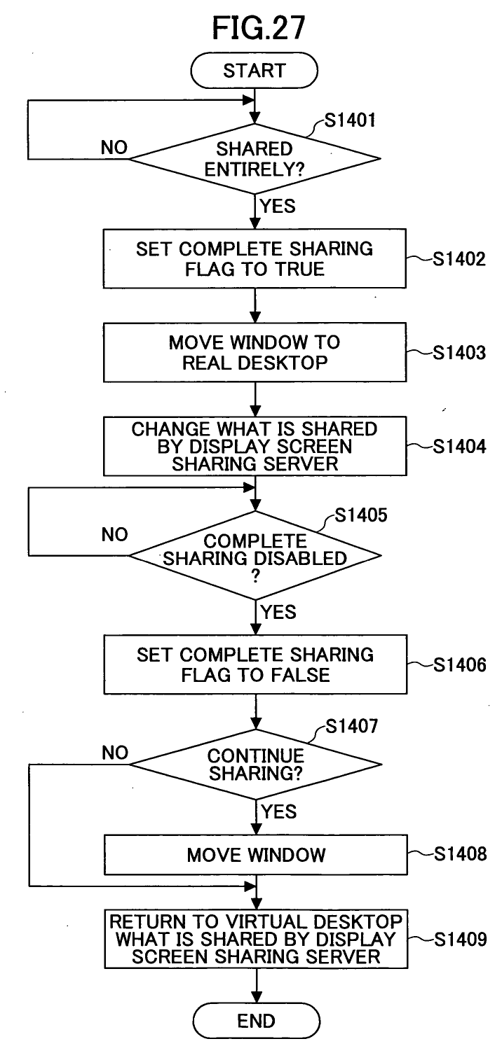

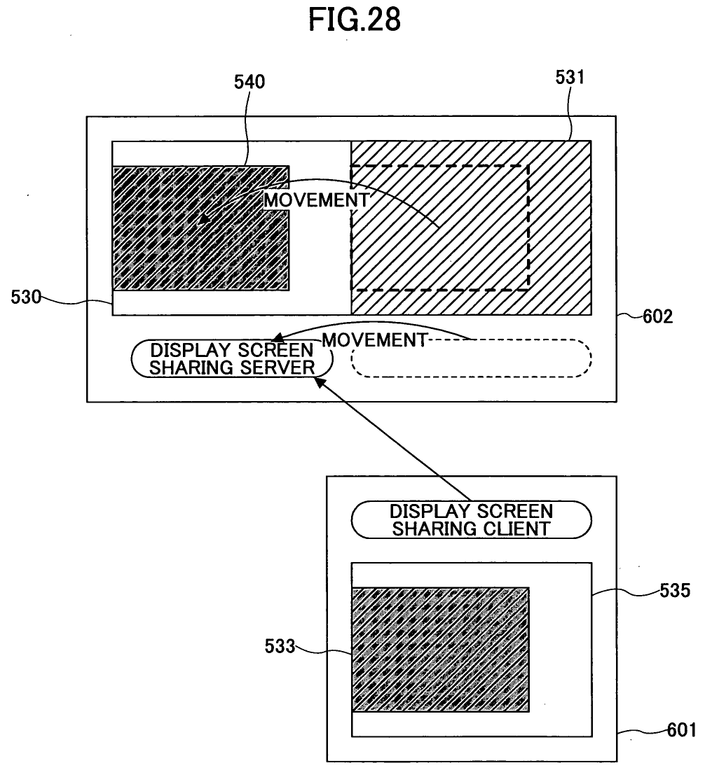

FIG. 27 is a flowchart of a process performed by the display screen sharing server according to the third embodiment. FIG. 28 is an illustrative drawing for explaining a display screen operation according to the third embodiment.

The window management unit of the display screen sharing server monitors whether the window of a shared application is shared in its entirety. If it is ascertained at step S1401 that the display screen is shared in its entirety by the client, the complete sharing flag is set to TRUE at step S1402.

At step S1403, the display screen sharing server moves the application window from the virtual desktop display screen to the real desktop display screen. In so doing, the movement is made such that the display area of the application on the virtual desktop display screen coincides with its destination on the real desktop. The way the window moves is shown in FIG. 28. FIG. 28 illustrates the display screen moving from the display screen 531 to the display screen 540.

After this, at step S1404, the display screen sharing server stops sharing the display screen data of the window that is displayed on the virtual desktop display screen. The display screen sharing server changes the area of the shared display screen, such that the display screen area of the application A presented on the real desktop display screen is now subjected to display screen sharing.

Under this condition, the information processing apparatus B 602 and the information processing apparatus A 601 ensure that the display areas of the application are synchronized. Namely, when the shared display screen is moved by operating the information processing apparatus A 601, the window of the application is also moved on the information processing apparatus B 602 according to the amount of the movement. The same also applies in the case of opposite operations.

Next step S1405 and onward relate to the disabling of complete sharing. There are two types of processes depending on whether the display screen sharing client moves the window of the shared display screen so as to return to the normal sharing state from the complete sharing state, or the display screen sharing client or server terminates the sharing of the display screen.

If it is detected at step S1405 that complete sharing is disabled, the display screen sharing server sets the complete sharing flag to FALSE at step S1406. If it is ascertained at step S1407 that sharing continues, the application window is moved as instructed by the window control unit of the client.

As a result of this movement, the application window is placed at such position that part of the window is displayed on the real desktop display screen, and the remainder is displayed on the virtual desktop display screen as shown in FIG. 16.

If it is ascertained at step S1406 that sharing does not continue, the sharing of the display screen area of the application A on the real desktop is disabled at step S1409. Then, the window displayed on the virtual desktop display screen is again placed in the normal state of being shared.

When the program of the display screen sharing server is to be terminated, the operations as described above are performed first as a terminating process, and, then, the process of the program is terminated.

### Embodiment 4

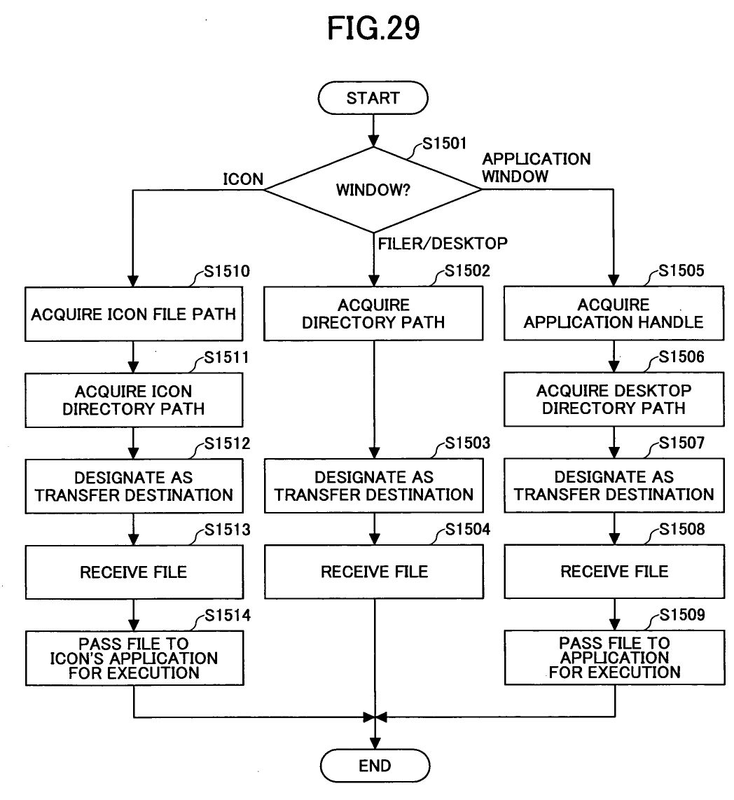

In the following, the transfer of a file will be described. FIG. 29 is a flowchart of a process performed by the information processing apparatus that receives a file according to the present embodiment. FIG. 29 shows a process that follows step S103 of FIG. 5.

This flowchart is applicable to the case in which a file is transferred from the display screen sharing client to the server, or to the case in which a file is transferred from the server to the client, whichever the case may be.

At step S1501, the window situated where the file is dropped is checked. If this window is a filer, the directory path currently indicated by the filer is identified at step S1502. At step S1503, this directory path is selected as a file transfer destination.

If the position where the file was dropped corresponds to part of the desktop where noting is displayed, the directory path of the currently displayed desktop display screen is identified at step S1502. At step S1503, this directory path is selected as a file transfer destination. At step S1504, the file is received.

If the window is found to be an application window at step S1501, the window handle of the application is acquired and stored in memory at step S1505. The desktop is then selected as the destination of the file transmission. At step S1506, the directory path of the desktop is identified. At step S1507, the identified directory path is selected as the destination. At steps S1508, the file is received. After the file is received, the display screen sharing client or display screen sharing server passes the received file to the application whose window handle was acquired as described above, thereby executing the application. For example, the file path of the executable file of the application is identified, and a process is executed that performs the application with a parameter specifying the received file.

If the window is found to be an application icon at step S1501, the file path of the icon is identified and stored in memory at step S1510. At step S1511, the directory path of the icon, i.e., the directory path of the folder in which the icon is located, is identified. At step S1512, the identified directory path is selected as the destination. At steps S1513, the file is received. After the file is received, the display screen sharing client or display screen sharing server causes the identified file of the icon to open the file.

It should be noted that if the window is found to be an application window at step S1501, the file may be transferred to a predetermined folder, rather than using the desktop as the destination. Further, if the file is dropped on an icon having no executable application, the file is transferred to the directory where the icon is located.

### Embodiment 5

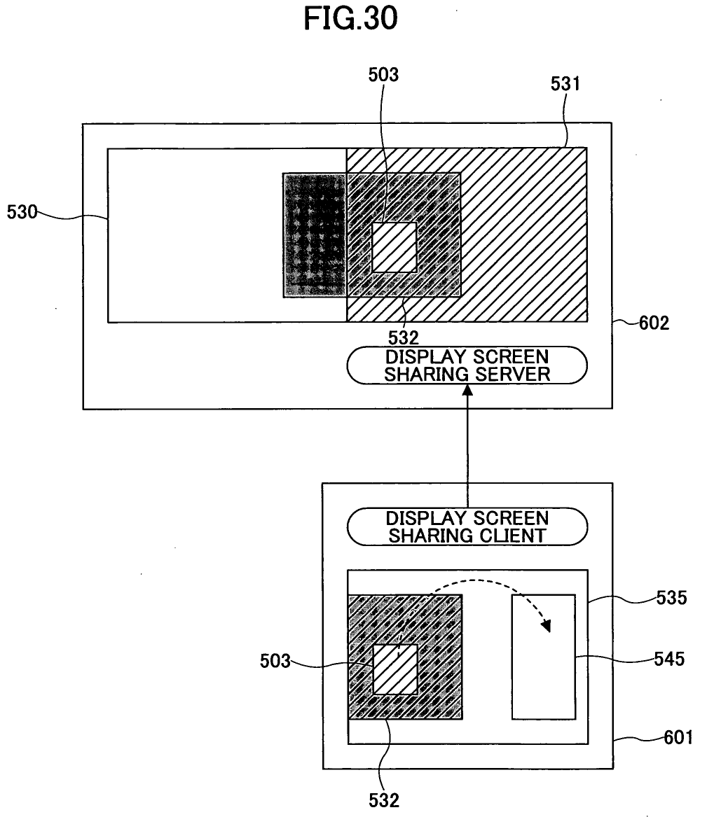

In the following, a description will be given of a process performed when the operation as shown in FIG. 30 is performed. FIG. 30 is an illustrative drawing showing the operation that drags and drops the file 503 on an application window 545.

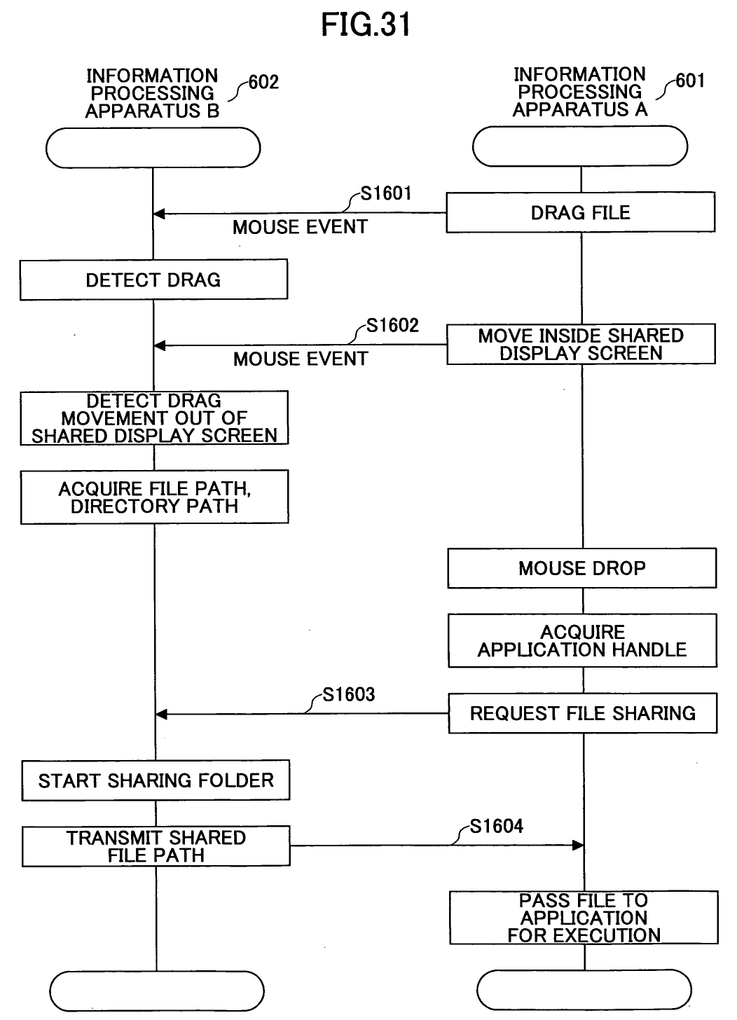

FIG. 31 is a sequence chart showing exchanges between the display screen sharing server and the display screen sharing client according to the fifth embodiment. At step S1601, the fact that the file is dragged is reported as a mouse event. In response, the display screen sharing server detects the drag.

At step S1602, a mouse event is reported that indicates the movement of the file out of the shared display screen. In response, the display screen sharing server detects that the file has been moved out of the shared display screen, and identifies the file path and the directory path.

At the display screen sharing client, the file is dropped, and the handle of the application situated at the position of the drop is identified. At step S1603, a file sharing request is issued.

The display screen sharing server starts sharing the folder in which the file is stored, and transmits the shared file path at step S1604. The display screen sharing client passes the file to the application, thereby executing the application.

AS the folder in which the file is stored is shared as described above, there is no need to actually transfer the file to the information processing apparatus A 601. Further, any editing performed on the file at the information processing apparatus A 601 will be reflected in the file of the information processing apparatus B 602.

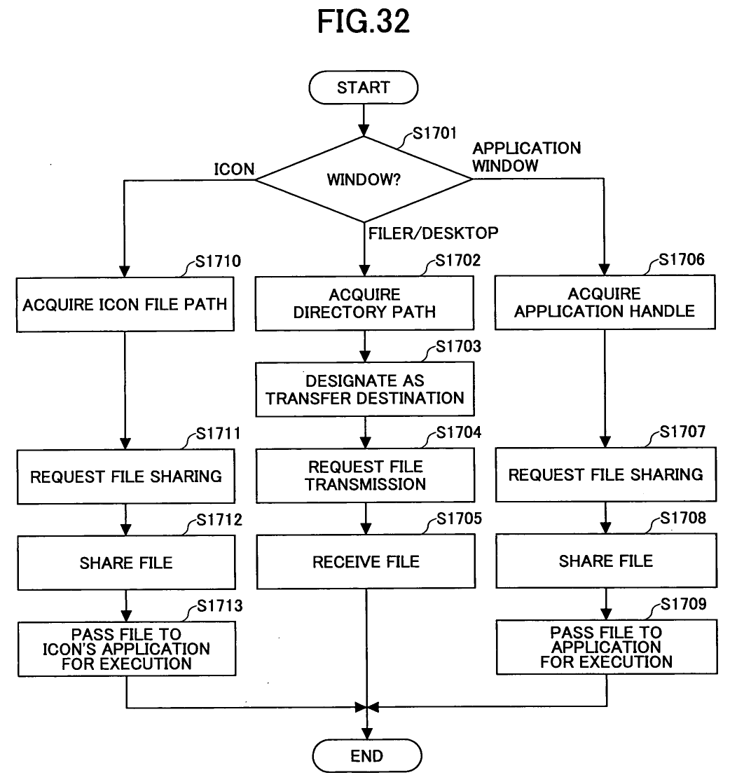

FIG. 32 is a flowchart of a process performed by the display screen sharing client according to the fifth embodiment.

At step S1701, the window situated where the file is dropped is checked. If this window is a filer, the directory path currently indicated by the filer is identified at step S1702. At step S1703, this directory path is selected as a file transfer destination.

If the position where the file was dropped corresponds to part of the desktop where noting is displayed, the directory path of the currently displayed desktop display screen is identified at step S1702. At step S1703, this directory path is selected as a file transfer destination.

At step S1704, a file transfer request is issued. At step S1705, the file is received.

If the window is found to be an application window at step S1701, the window handle of the application is acquired and stored in memory at step S1706. The desktop is then selected as the destination of the file transmission. At step S1707, a file sharing is requested. At step S1708, the file is shared. After the file is shared, the shared file is passed at step S1709 to the application whose window handle was acquired as described above, thereby executing the application.

If the window is found to be an application icon at step S1701, the file path of the icon is identified and stored in memory at step S1710. At step S1711, a file sharing is requested. At step S1712, the file is shared. After the file is shared, the shared file is passed at step S1713 to the application indicted by the icon, thereby executing the application.

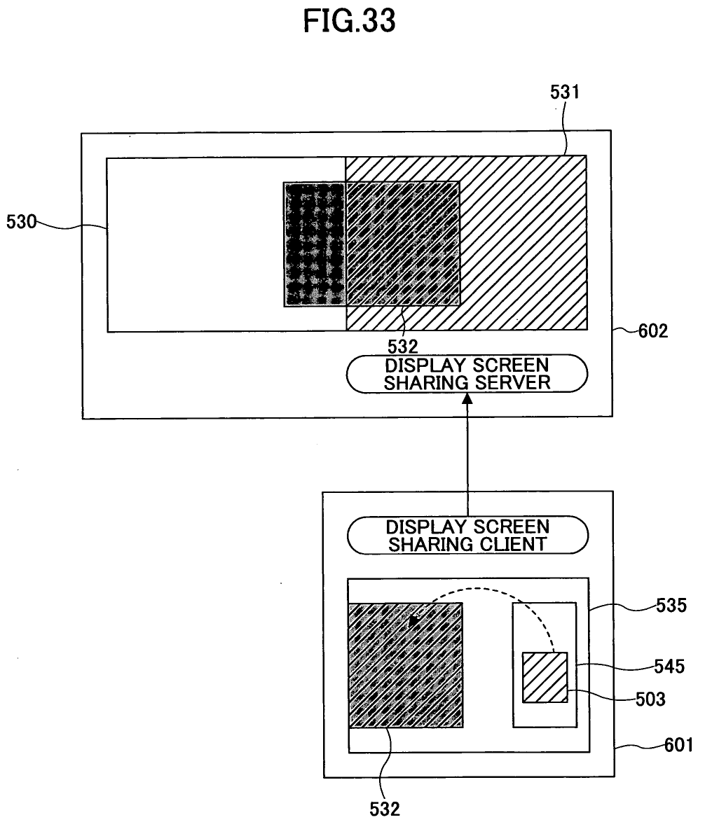

As shown in FIG. 33, a file of the information processing apparatus A 601 having the display screen sharing client running thereon may be dragged and dropped on an application window displayed at the information processing apparatus A 601 as a shared display screen while the application is running on the information processing apparatus B 602. In this case also, the operations described in the above example can be performed by exchanging the display screen sharing server with the display screen sharing client.

### Embodiment 6

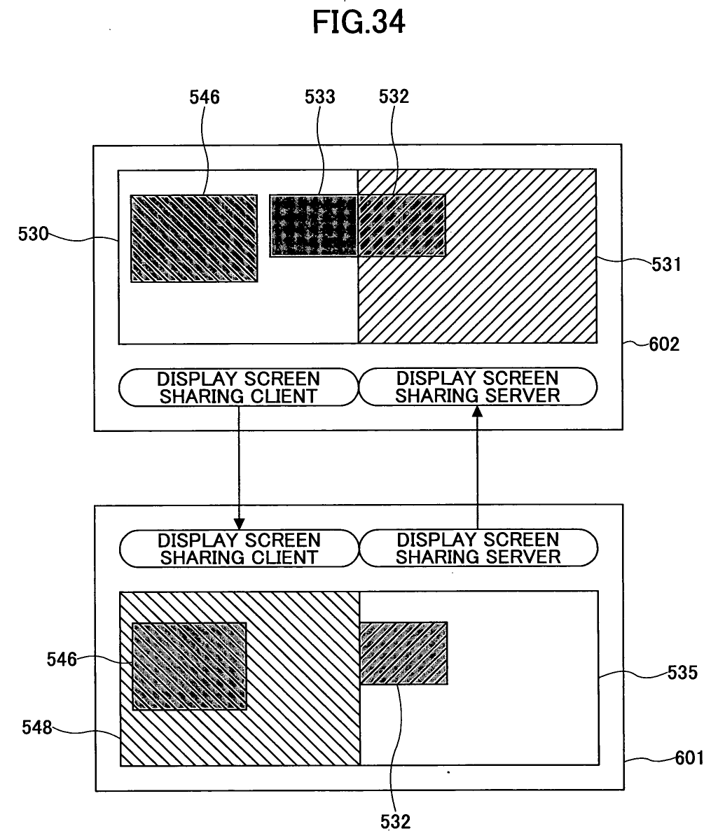

In the following, an example in which a display screen is shared bi-directionally between two information processing apparatuses will be described. FIG. 34 is an illustrative drawing showing a case in which a display screen sharing client runs also on the information processing apparatus B 602, and a display screen sharing server runs also on the information processing apparatus A 601. The window 533 is that of the application A, and the window 546 is that of an application B. A window 548 is a virtual desktop display screen.

Namely, the display screen sharing client of the information processing apparatus A 601 is connected to the display screen sharing server of the information processing apparatus B 602, and the display screen sharing client of the information processing apparatus B 602 is connected to the display screen sharing server of the information processing apparatus A 601. A client and a paired server share an application window. The connections established in this manner to achieve mutual display screen sharing are hereinafter referred to as “cross-connection”.

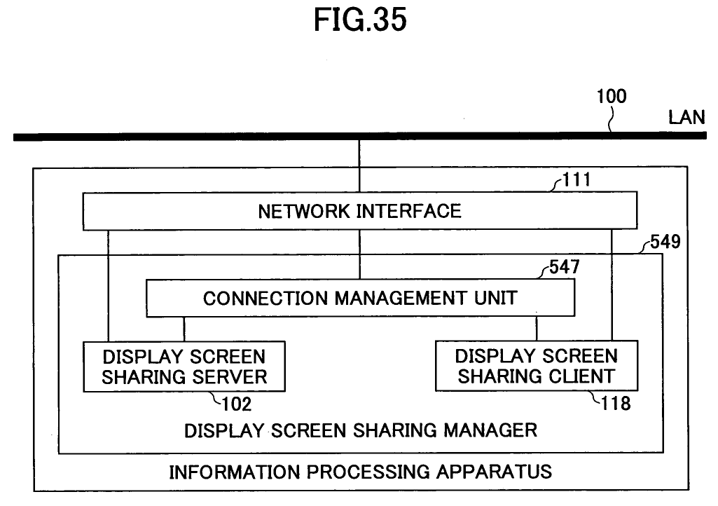

FIG. 35 is a block diagram of the information processing apparatus A 601 or 602 shown in FIG. 34. Software referred to as a display screen sharing manager 549 is running on the information processing apparatus. The display screen sharing manager 549 includes a connection management unit 547 for managing connections, the display screen sharing server 102, and the display screen sharing client 118.

The connection management unit 547 controls and manages the connections of the display screen sharing server 102 and the display screen sharing client 118. Further, the connection management unit 547 has the function to support the setting of the virtual desktop display screen of the display screen sharing server.

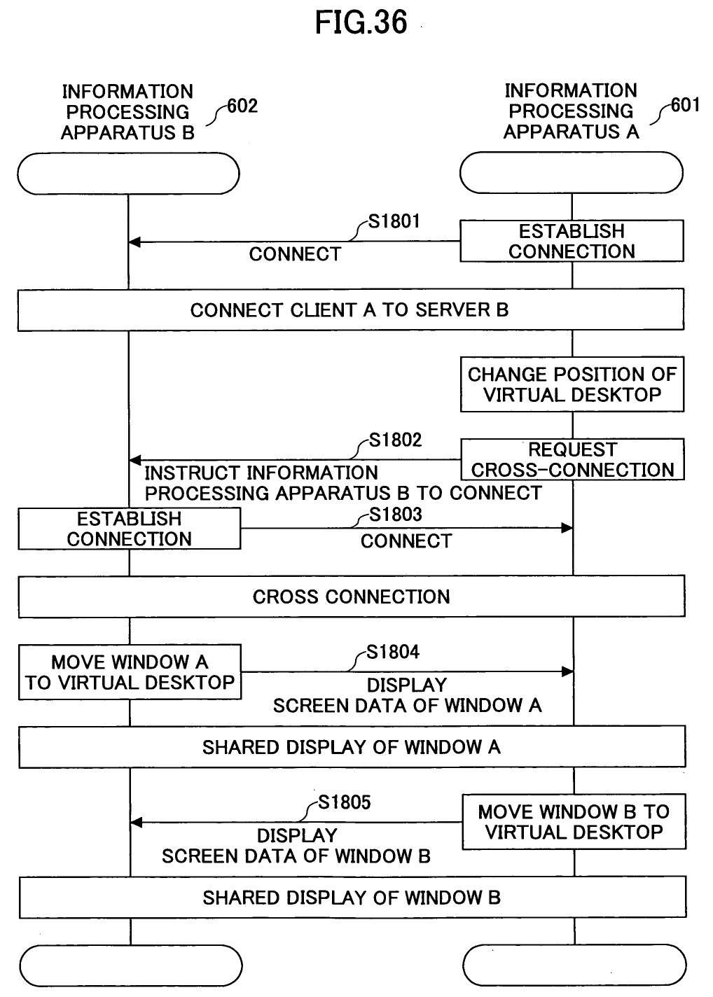

FIG. 36 is a sequence chart showing an example of the sequence for establishing a cross-connection. In the following, the sequence for establishing a cross-connection as shown in FIG. 34 will be described. In FIG. 36, the display screen sharing client of the information processing apparatus A 601 is referred to as a client A, the display screen sharing server of the information processing apparatus B 602 referred to as a server B, the window of the application A referred to as a window A, and the window of the application B referred to as a window B.

On each of the information processing apparatus A 601 and information processing apparatus B 602, the display screen sharing manager and the display screen sharing server are running. In an initial state, the virtual desktop display screen is placed on the right-hand side of the real desktop display screen.

At step S1801, the information processing apparatus A 601 establishes a connection with the information processing apparatus B 602, so that the display screen sharing client of the information processing apparatus A 601 is connected to the display screen sharing server of the information processing apparatus B 602.

In order to exchange a window across the same desktop border for the cross-connection, the virtual desktop display screen of the information processing apparatus A 601 needs to be placed on the left-hand-side of the real desktop display screen. The connection management unit thus moves the virtual desktop display screen to the left with respect to the display screen sharing server.

The connection management unit requests at step S1802 that the display screen sharing client of the information processing apparatus B 602 connect with the display screen sharing server on the local side. Upon receiving this request, the connection management unit of the information processing apparatus B 602 arranges that the client is connected to the display screen sharing server of the information processing apparatus A 601. At step S1803, the establishment of the connection is reported. This achieves a cross-connection.

The window A displayed at the information processing apparatus B 602 is moved to the virtual desktop display screen. In response, the display screen data of the window A is transmitted at step S1804. As a result, the portion that is displayed on the virtual desktop display screen is displayed as a shared display screen at the information processing apparatus A 601 as having the same arrangement as it appears on the virtual desktop display screen of the information processing apparatus B 602.

Thereafter, the window of the application B running on the information processing apparatus A 601 is dragged and moved to the left, such that the entirety of the window is displayed inside the virtual desktop display screen. In response, the display screen data of the window B is transmitted at step S1805. As a result, as shown in FIG. 34, the display screen of the application B is displayed as a shared display screen at the information processing apparatus B 602.

With this provision, it becomes possible to share application windows between two personal computers by moving the windows by mouse operations.

Further, file transfer may be performed by drag-&-drop operation. Also, file transfer may be performed by dragging and dropping the file on an application window, thereby making the application execute the received file.

Moreover, a file may be dragged and dropped on an application window or an icon of an executable program, so that the file provided at the personal computer on the drag side is shared by the personal computer on the drop side, and is opened by the application.

Namely, two separate personal computers can be handled as if they were a single personal computer. One exception is that the two personal computers cannot perform independent, simultaneous operations when one of the two personal computers is remotely controlling the shared display screen.

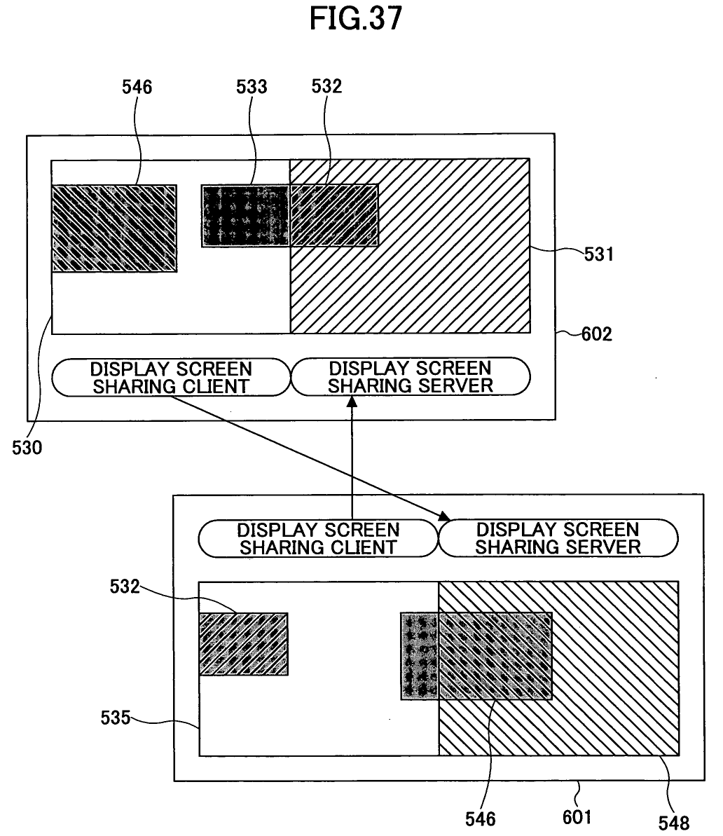

The arrangement of the display screens at the information processing apparatus A 601 shown in FIG. 34 may be reversed as shown in FIG. 37. Specifically, the virtual desktop display screen may be always placed on the right-hand side of the real desktop display screen for the sharing of display screens. If it is desired that the left-hand side is used to receive a shared display screen, and that the right-hand side is used to let a display screen be viewed as a shared display screen, such an arrangement may be a preferred choice. In this example, this arrangement is achieved by omitting the function of the connection control unit to change the position of the virtual desktop display screen in the operation flow shown in FIG. 36.

In the following, a description will be given of an example in which a single information processing apparatus performs the sharing of display screens of two or more information processing apparatuses. Here, it is assumed that the display screen sharing server can control the position of the virtual desktop display screen.

### Embodiment 7

In all the embodiments that follow, reference numerals 701, 702, 703, and 704 indicate real desktop display screens, and reference numerals 721, 722, 723, 724, 952, 953, 954, 955, and 956 indicate virtual desktop display screens. Further, reference numerals 801, 802, 803, and 804 indicated application windows of one type or another. Reference numerals 901, 902, 903, and 904 indicate shared display screens.

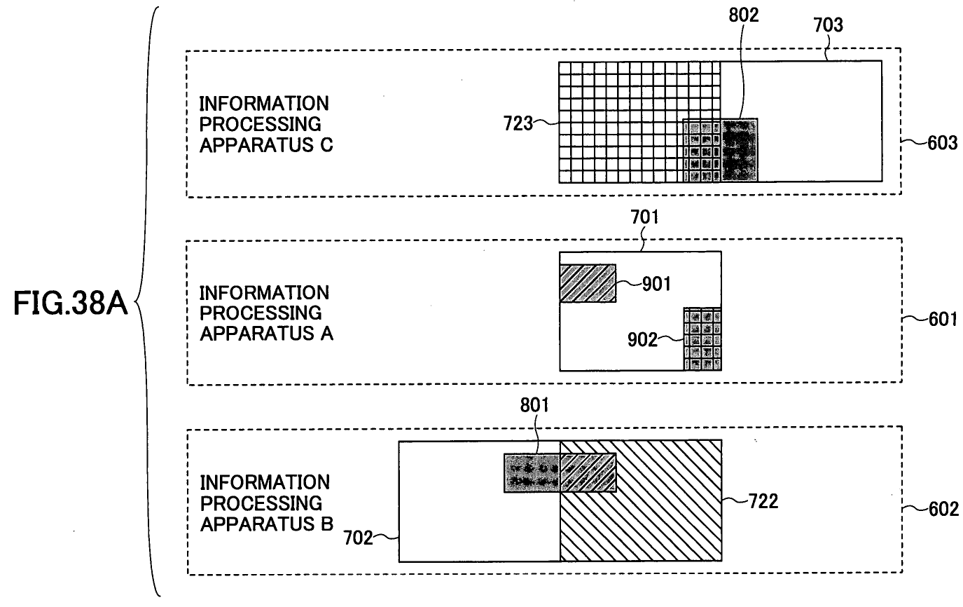

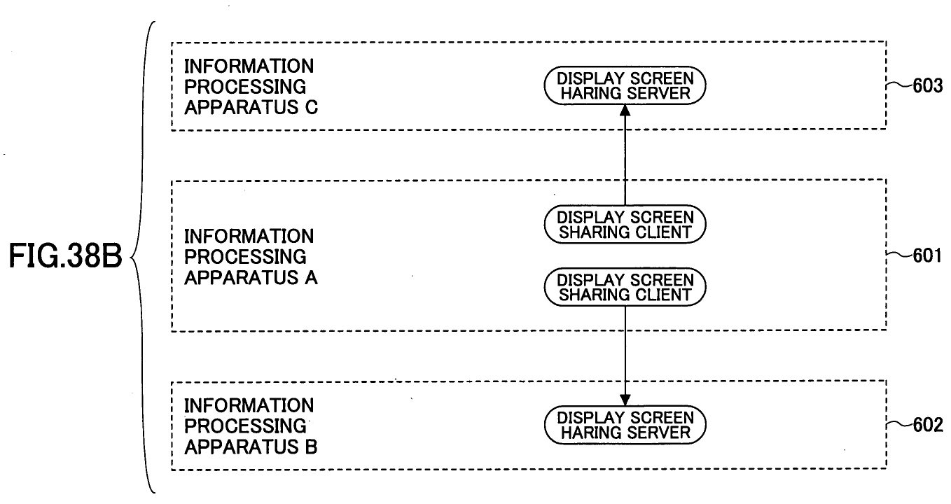

FIGS. 38A and 38B are illustrative drawings showing examples of display screens and a system configuration, respectively. As shown in FIGS. 38A and 38B, three information processing apparatuses, i.e., the information processing apparatus A 601, the information processing apparatus B 602, and the information processing apparatus C 603, are used in this system. A display screen sharing server is running on each of the information processing apparatuses B 602 and C 603. At the information processing apparatus C 603, the virtual desktop display screen 723 is placed on the left-hand side of the real desktop display screen 703.

Only a display screen sharing client is running on the information processing apparatus A 601. The shared display screen 901 corresponds to the window 801 of the application A on the information processing apparatus B 602, and the shared display screen 902 corresponds to the window 802 of the application B on the information processing apparatus C 603.

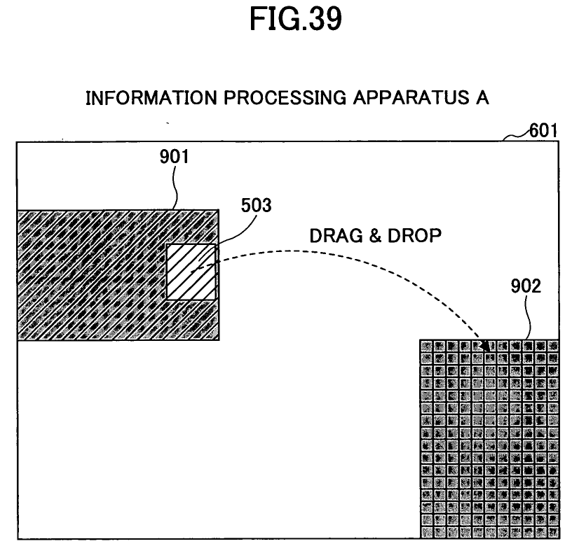

In this configuration, the information processing apparatus A 601 is operated as shown in FIG. 39 so as to drag the file 503 of the information processing apparatus B 602 displayed on the shared display screen 901 and to drop it on the application window of the information processing apparatus C 603 displayed on the shared display screen 902. A description will be given of the operations performed in such a case.

It is assumed that the application displayed as the shared display screen 902 serving as the destination of the drop operation is a filer. In this case, direct file transfer from the information processing apparatus B 602 to the information processing apparatus C 603 is achieved by adding the file transfer method previously described (see FIG. 10) to the display screen sharing system described above.

In the next example, it is assumed that the application indicated as the shared display screen 902, which is the destination of the drop operation, is a general application window; In this case, provision can be made such that direct file transfer from the information processing apparatus B 602 to the information processing apparatus C 603 is achieved, and, also, the application selected as the destination by the drop operation opens the received file (FIG. 30).

Further, the application B displayed as the shared display screen 902 where the file is dropped is a general application window. In this case, provision can be made such that the information processing apparatus C 603 shares the file of the information processing apparatus B 602, and the application indicated as the destination by the drop operation opens the shared file (FIG. 36).

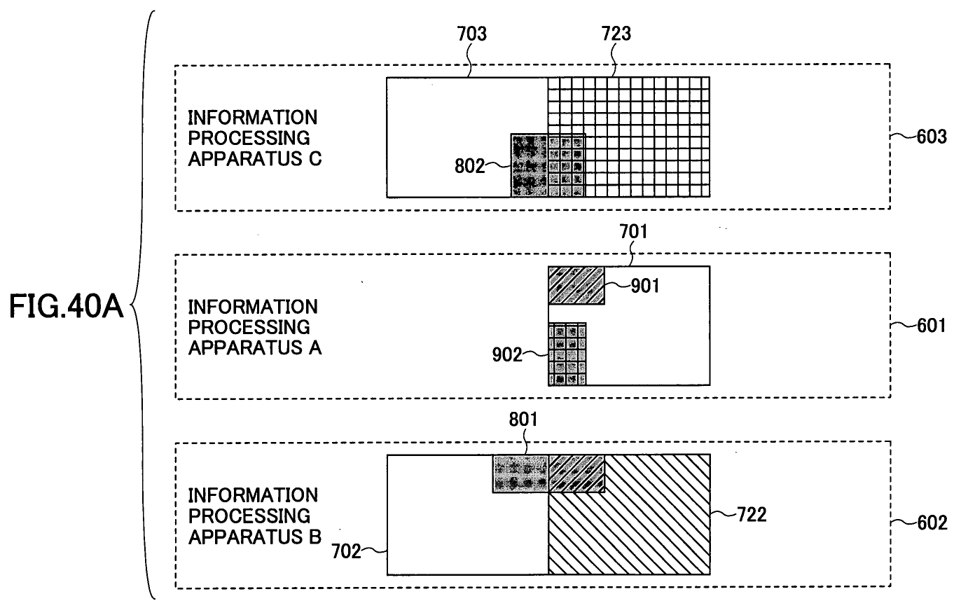

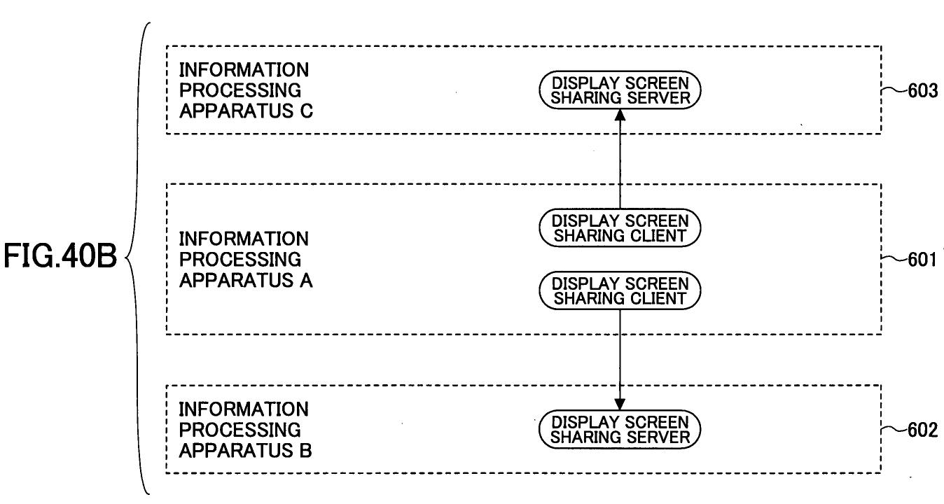

In the next example, as shown in FIGS. 40A and 40B, the virtual desktop display screens 722 and 723 are placed on the right-hand side at the information processing apparatuses B 602 and C 603, respectively. At the information processing apparatus A 601, the shared display screens 901 and 902 are arranged on the left-hand side.

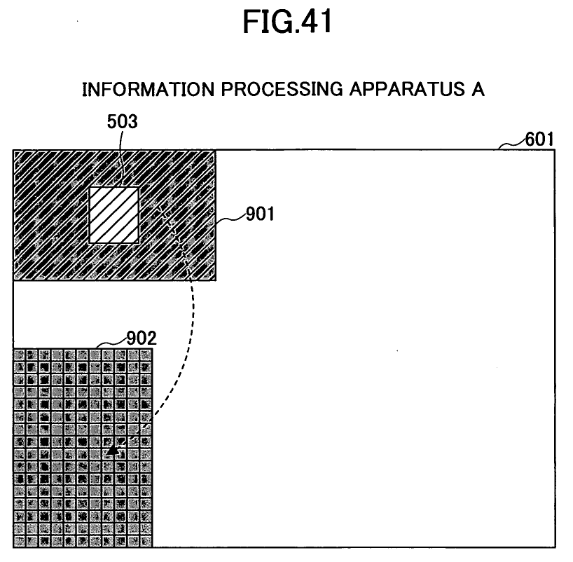

As shown in FIG. 41, the information processing apparatus A 601 may be operated so as to drag the file 503 of the information processing apparatus C 603 displayed on the shared display screen 901 and to drop it on the application window of the information processing apparatus B 602 displayed on the shared display screen 902, thereby transferring the file. The application may further be executed after the file transfer. Alternatively, the file of the information processing apparatus C 603 may be shared by the information processing apparatus B 602, and the application of the information processing apparatus B 602 may access the shared file.

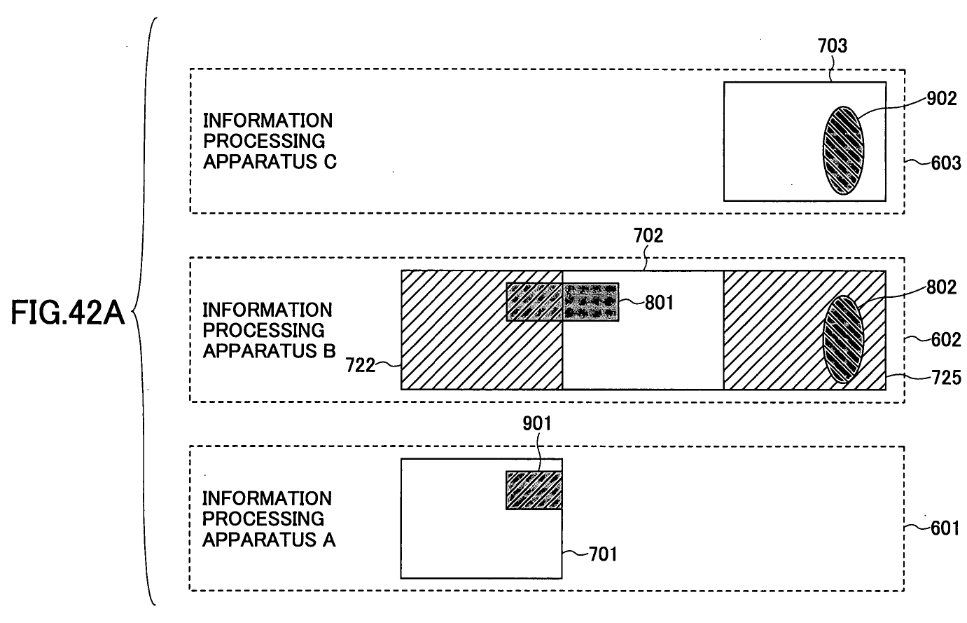

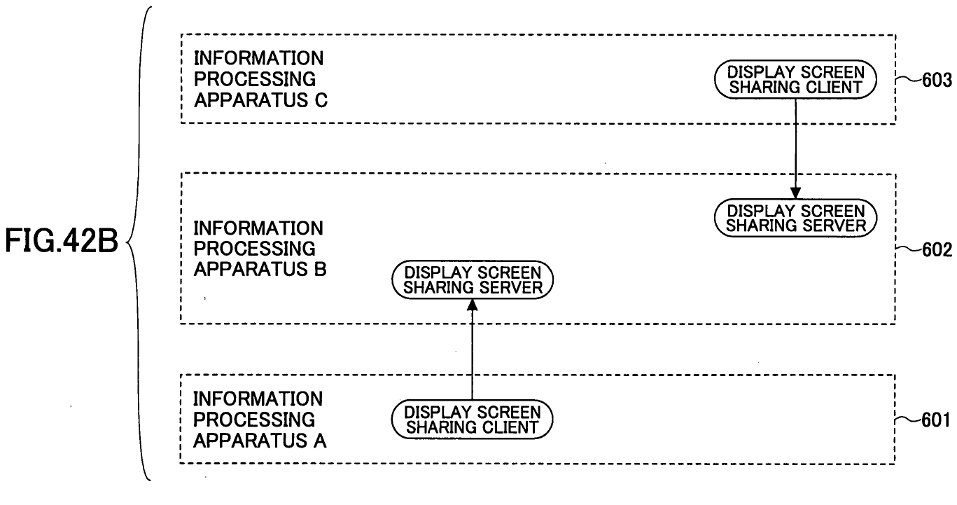

Various forms of connections between a plurality of information processing apparatuses will be described with reference to FIGS. 42A and 42B, FIGS. 43A and 43B, and FIGS. 44A and 44B. FIGS. 42A and 42B are illustrative drawings showing an example of connection by which a plurality of virtual desktop display screens are generated at a single information processing apparatus so as to achieve the sharing of two or more display screens.

Two virtual desktop display screens 722 and 725 are generated at the information processing apparatus B 602. The virtual desktop display screen 722 is connected to the display screen sharing client of the information processing apparatus A 601, and the virtual desktop display screen 725 is connected to the display screen sharing client of the information processing apparatus C 603. With this configuration, the shared display screen 901 corresponding to the window 801 of the application A is shared, and the shared display screen 902 corresponding to the window 802 of the application B is shared.

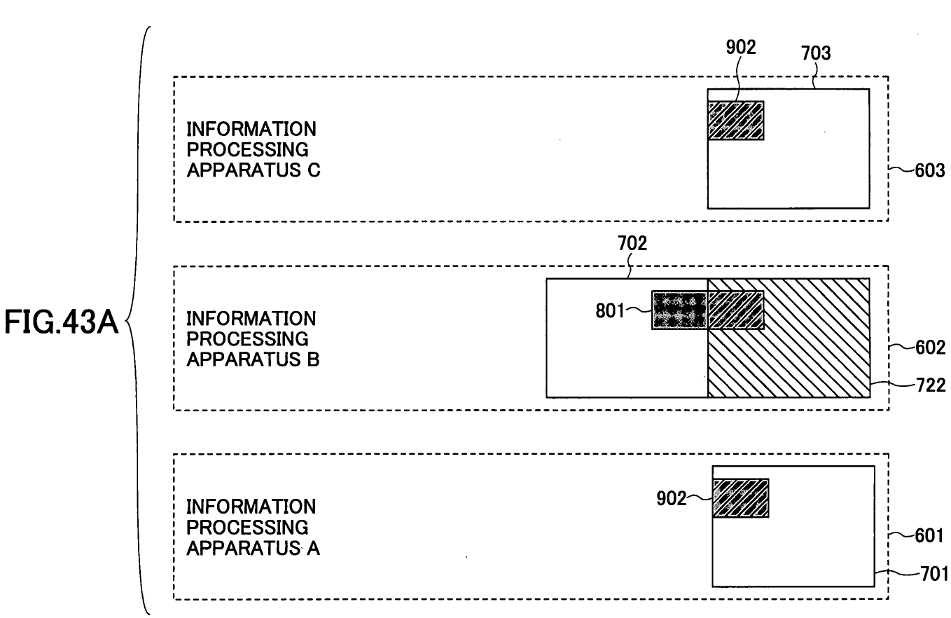

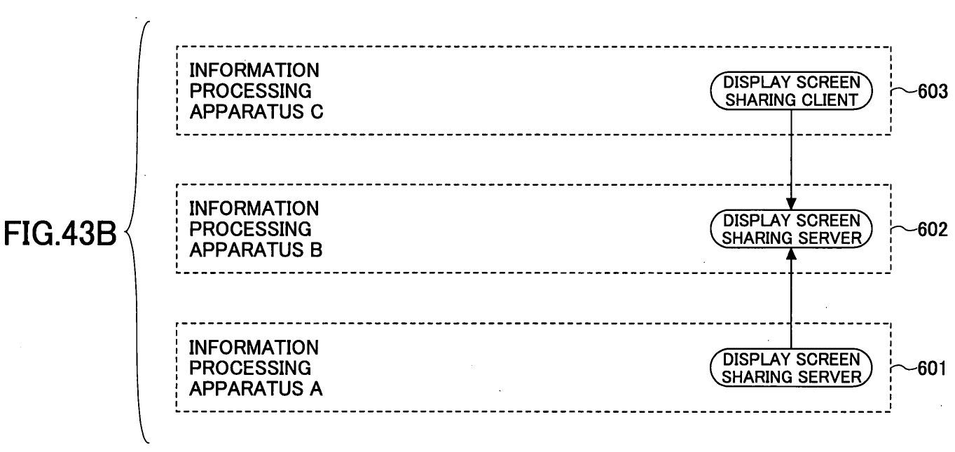

FIGS. 43A and 43B are illustrative drawings showing an example in which two display screen sharing clients are connected to a single display screen sharing server so as to share the connections. The display screen sharing server is running on the information processing apparatus B 602 where the window 801 of the application A is shared.

Further, the information processing apparatuses A 601 and C 603 are connected to this server by use of the display screen sharing clients. The information processing apparatus A 601 and the information processing apparatus C 603 are thus able to access and operate the window of the application A of the information processing apparatus B 602. Each of the information processing apparatuses B 602 and C 603 can make the application A of the information processing apparatus B 602 execute a local file by dragging and dropping the file on the shared display screen, and can transfer a file between the information processing apparatuses A 601 and 602 or between the information processing apparatuses B 602 and C 603, whichever is selected.

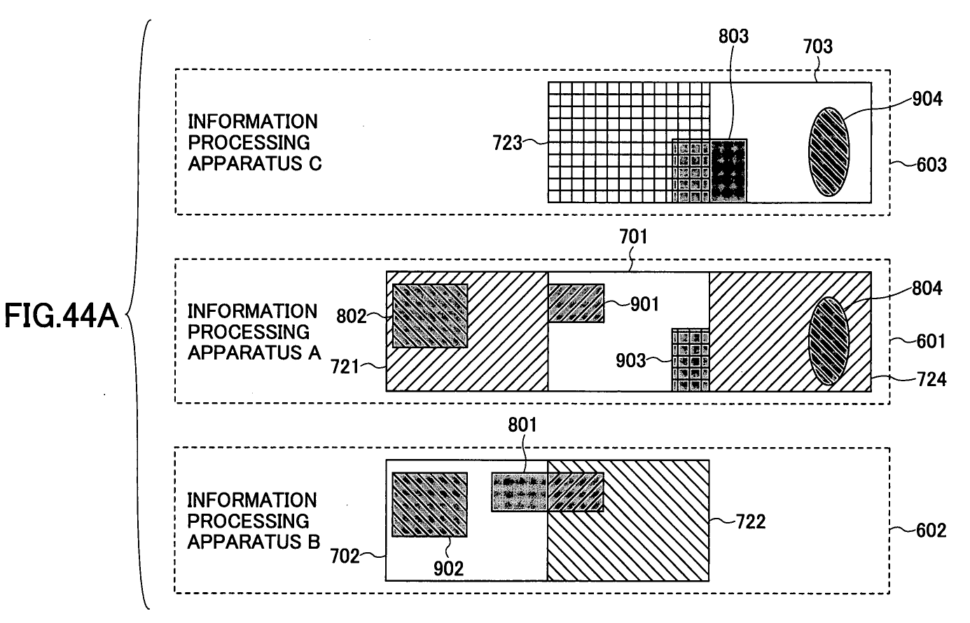

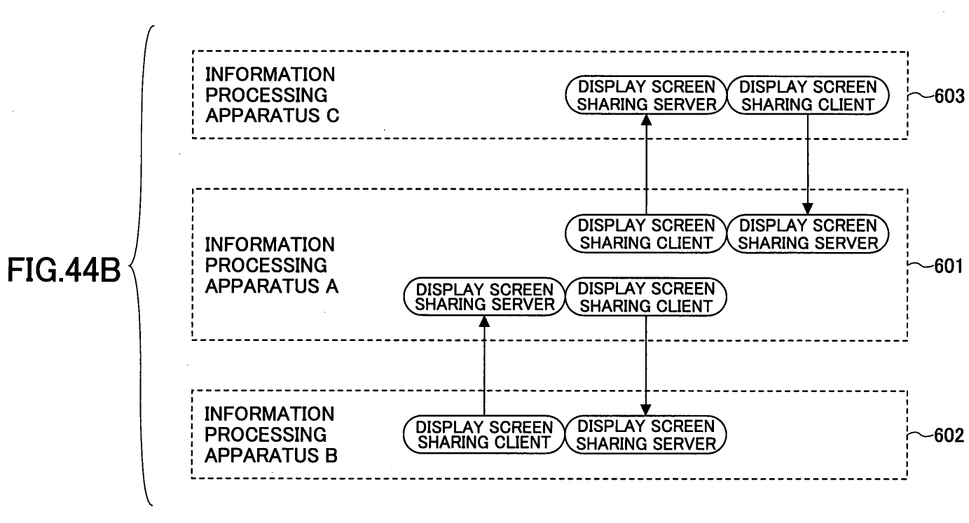

FIGS. 44A and 44B are illustrative drawings showing a case in which the information processing apparatus A 601 is connected to the information processing apparatus B 602 and to the information processing apparatus C 603.

In FIGS. 44A and 44B, the real desktop display screen 701, the virtual desktop display screen 721, and the virtual desktop display screen 724 are displayed at the information processing apparatus A 601. On the virtual desktop display screen 724 are displayed the window 804 of the application D and the shared display screen 904. On the real desktop display screen 701 are displayed the shared display screens 901 and 903. Further, the window 803 of the application C is displayed on the information processing apparatus C 603.

The shared display screen 901 (the shared display screen of the window 801 of the application A at the information processing apparatus B 602) displayed at the information processing apparatus A 601 may be moved to the virtual desktop display screen 722 such as to be displayed by the display screen sharing client of the information processing apparatus C 603.

Namely, the application A of the information processing apparatus B 602 may share a display screen with the information processing apparatus C 603 (double sharing) via the shared display screen 902 of the information processing apparatus B 602. In this case, provision may be made such that the information processing apparatus C 603 and the information processing apparatus B 602 can transfer a file directly without using the information processing apparatus A 601 as an intermediary.

Combinations other than those described above may as well be implemented.

### Embodiment 8

In the following, a description will be given of a process performed by the connection management unit of FIG. 35 to select a party to be connected. As previously described, the connection management unit controls and manages the connections of the display screen sharing client and the display screen sharing server. Further, the connection management unit includes a means to register a party that is authorized to be connected, and also includes a means to select a party to be selected.

In the following, the process to select a party to be connected will be described by taking an example. In this example, the information processing apparatus A 601, the information processing apparatus B 602, the information processing apparatus C 603, an information processing apparatus D, and an information processing apparatus E have the IP address and PC name of each other registered therein. Under this condition, the selection process is performed.

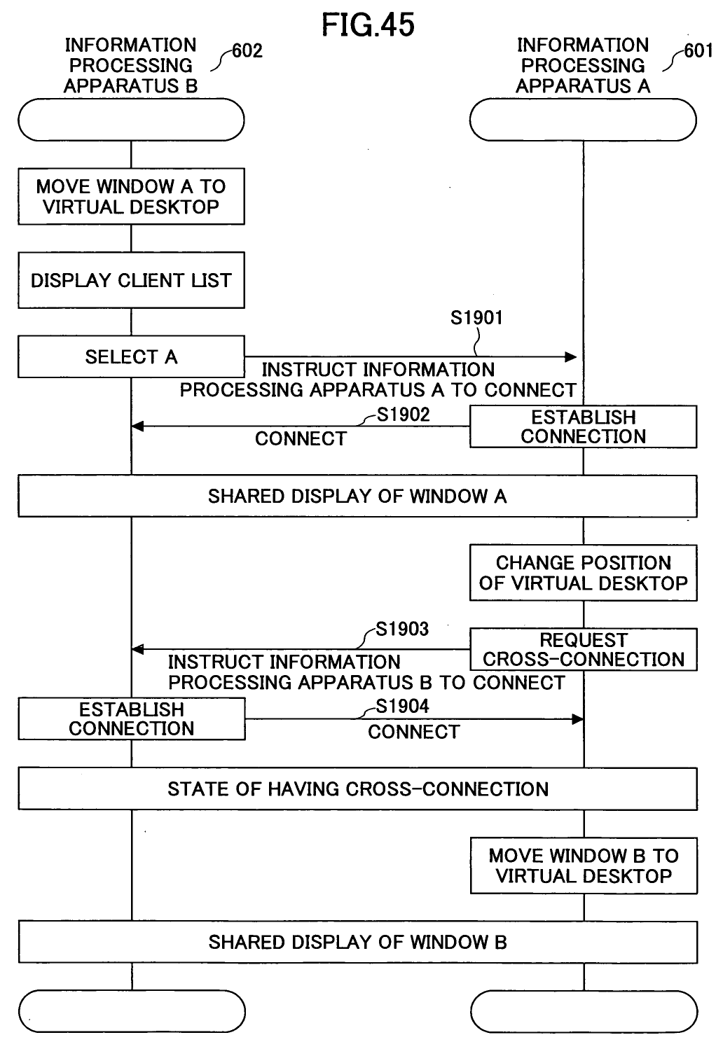

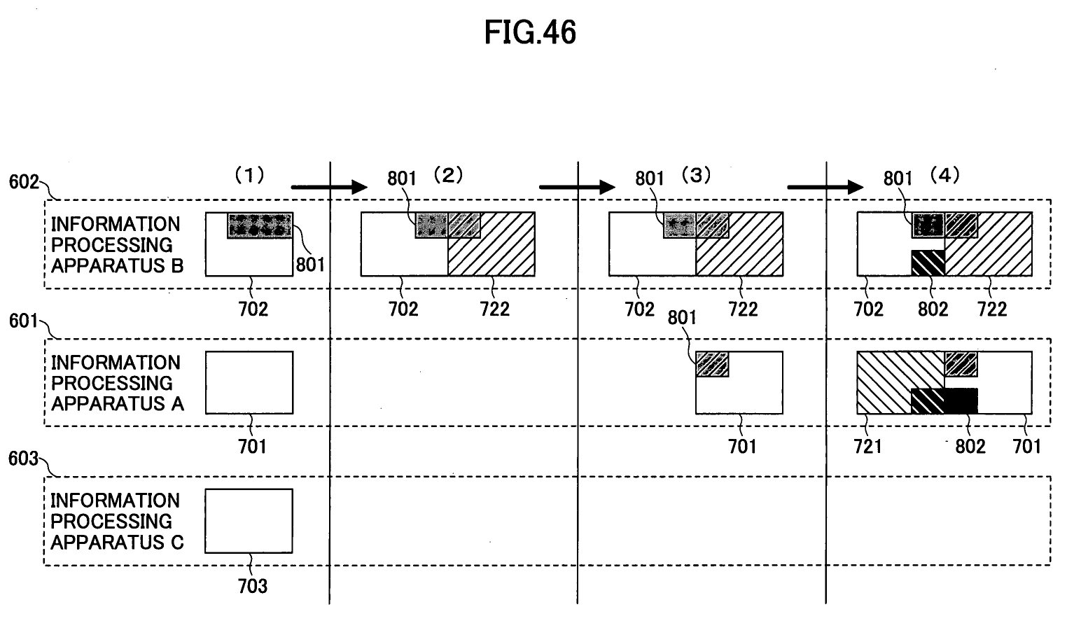

FIG. 45 is a sequence chart showing a process performed by the connection management unit according to the eighth embodiment. FIG. 46 is an illustrative drawing showing display transitions according to the eighth embodiment. It is assumed that the display screen sharing server is running on the information processing apparatus B 602, but no client is connected to this information processing apparatus B 602. An example will be considered here in which the information processing apparatus A 601 attempts to let the application A viewed as a shared display screen.

The information processing apparatus B 602 is operated first to move the window of the application A to the right, such that the window is displayed on the virtual desktop display screen 722 ((1) to (2) in FIG. 46). The connection management unit of the information processing apparatus B 602 detects the commencement of display screen sharing, and presents a registered client list. Namely, the information processing apparatus A 601, the information processing apparatus B 602, the information processing apparatus D, and the information processing apparatus E are presented as choices. The user of the information processing apparatus B 602 selects the information processing apparatus A 601.

In response, the connection management unit of the information processing apparatus B 602 instructs the information processing apparatus A 601 at step S1901 to connect with the information processing apparatus B 602. Upon receiving this instruction, the connection management unit of the information processing apparatus A 601 makes the display screen sharing client establish a connection with the information processing apparatus B 602 at step S1902. After the establishment of connection, the window of the application A is shared as shown at (3) in FIG. 46.

Further, the connection management unit of the information processing apparatus A 601 establishes a cross-connection with the information processing apparatus B 602. In the initial state, the position of the virtual desktop display screen 721 is on the right-hand side of the real desktop display screen 701. This arrangement is changed such that the virtual desktop display screen 721 is positioned on the left-hand side of the real desktop display screen 701.

Then, instruction is given at step S1903 to the information processing apparatus B 602 to establish connection with the information processing apparatus A 601. At step S1904, the connection control unit of the information processing apparatus B 602 establishes a connection with the information processing apparatus A 601, thereby completing a cross-connection.

After this, the window 801 may be moved to the right at the information processing apparatus B 602 to be displayed on the virtual desktop display screen 722. In this case, a shared display screen is displayed at the information processing apparatus B 602 as shown at (4) in FIG. 46.

A cross-connection was established in the above-described process. The establishment of cross-connection, however, is not mandatory.

In the following, a description will be given of a method that is utilized to display information on a special display screen such as a large-size display screen. The connection control unit includes a means to register an information processing apparatus capable of large-size screen display with a special identifier attached thereto. The information processing apparatus A 601, for example, may be connected to a projector to display a large-size screen. The connection control unit of each of the other information processing apparatuses registers therein the fact that the information processing apparatus A 601 is equipped with a large-size display screen.

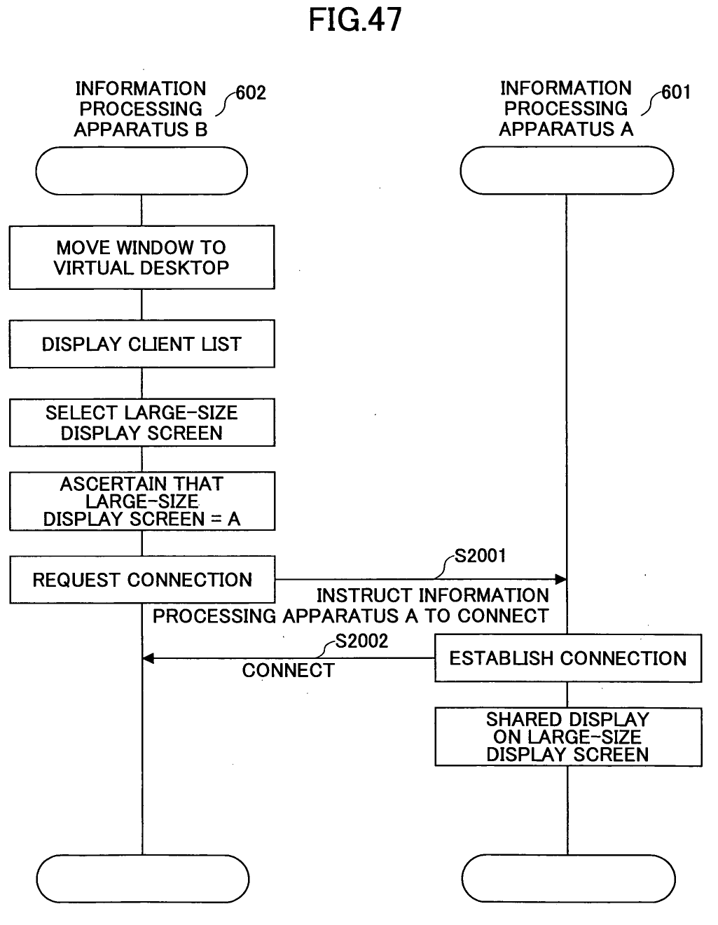

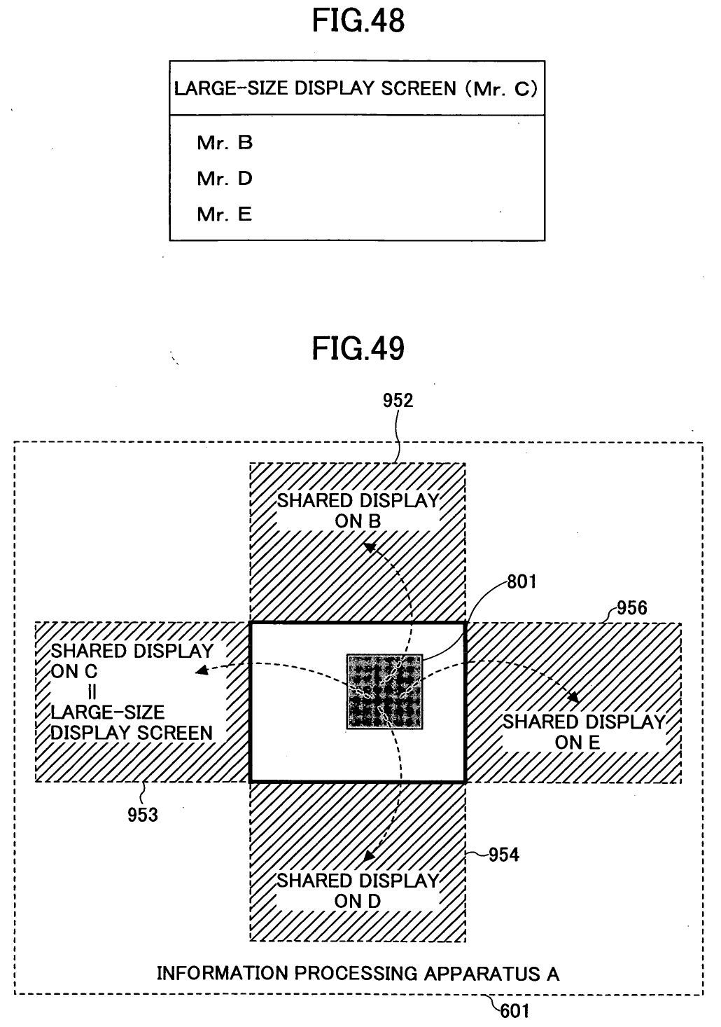

As shown in a flowchart of FIG. 47, the information processing apparatus B 602 is operated to move the window 801 of the application A to the right such that the window is displayed on the virtual desktop display screen ((1) to (2) in FIG. 46). In response, the connection management unit of the information processing apparatus B 602 detects the commencement of display screen sharing, and presents a registered-client list as shown in FIG. 48.

Namely, “Large-Size Screen”, “Mr. B” indicative of the information processing apparatus B 602, “Mr. D” indicative of the information processing apparatus D, and “Mr. E” indicative of the information processing apparatus E are presented as choices. The user of the information processing apparatus B 602 selects the large-size screen display. Based on the data of the client list, the connection management unit of the information processing apparatus ascertains that the information processing apparatus registered as the large-size screen is the information processing apparatus A 601. The connection management unit of the information processing apparatus B 602 then instructs the information processing apparatus A 601 connected to the projector to establish a connection with the information processing apparatus B 602 (step S2001 in FIG. 47).

Upon receiving this instruction, the connection management unit of the information processing apparatus A 601 makes the display screen sharing client establish a connection with the information processing apparatus B 602. After the establishment of connection, the window 801 of the application A is projected onto a large-size screen by the projector as shown at (3) in FIG. 46. Such a screen may be viewed by attendees at a conference, for example.

### Embodiment 9

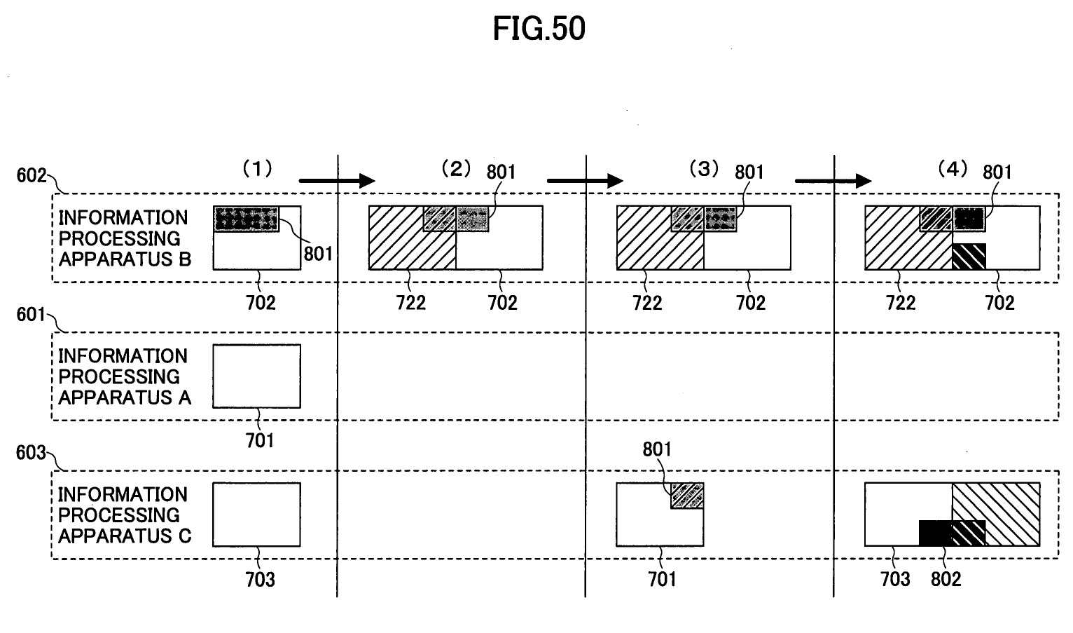

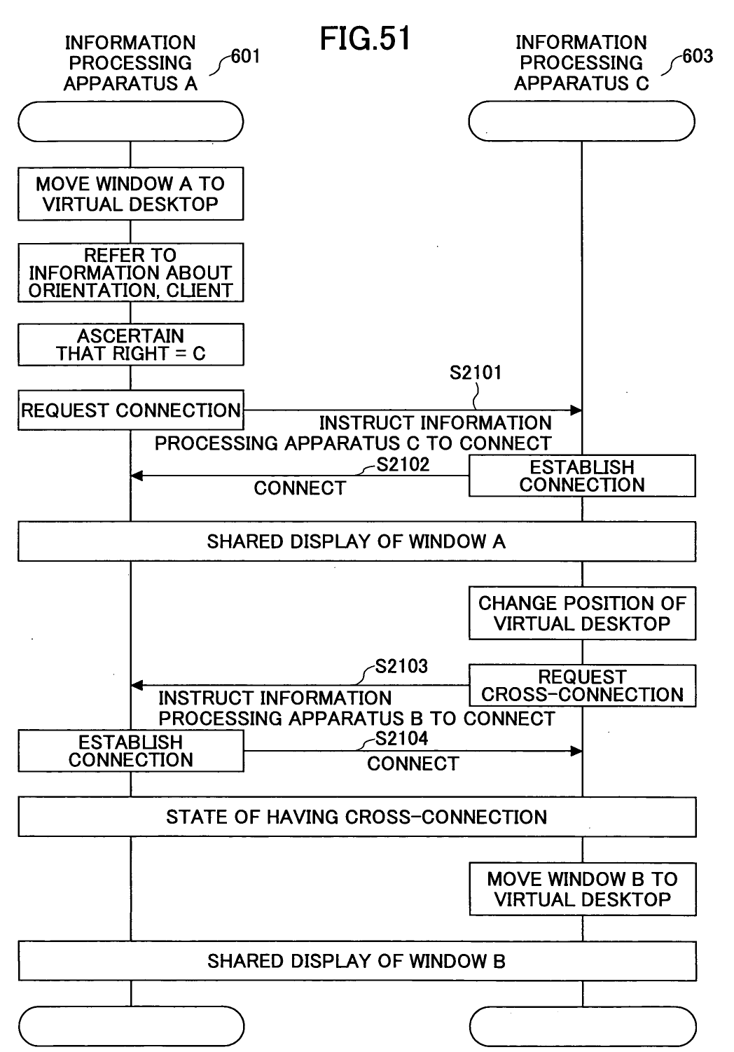

In the following, a description will be given of a case in which virtual desktop display screens are generated on the top, bottom, left, and right with reference to FIG. 49, FIG. 50, and FIG. 51. FIG. 49 is an illustrative drawing showing the display screen of the information processing apparatus A 601. Virtual desktop display screens 952, 953, 954, and 956 are generated on the top, left, bottom, and right, respectively. Each of them is activated by the display screen sharing server, and is ready to share a window displayed on the virtual desktop display screen. FIG. 50 is an illustrative drawing showing display screen transitions according to the ninth embodiment. FIG. 51 is a sequence chart showing a process performed by the connection management unit according to the ninth embodiment.

The connection management unit of the information processing apparatus A 601 registers the virtual desktop display screens corresponding to the respective information processing apparatuses B 602, C 603, D, and E as being on the top, on the left, on the bottom, and on the right, respectively, in a successive manner.

An example will be described here in which the information processing apparatus A 601 is operated so as to display the window 801 of the application A at the information processing apparatus C 603, which is connected to a projector capable of large-size screen display.

The virtual desktop display screen to be shared with the information processing apparatus C 603 is registered as the one on the left-hand side of the real desktop display screen. The window is thus moved to the left ((1) to (2) in FIG. 50). The connection management unit ascertains that the virtual desktop display screen on the left-hand side is registered as one for use in sharing a display screen with the information processing apparatus C 603. At step s2101, the connection management unit instructs the connection management unit of the information processing apparatus C 603 to establish connection with the information processing apparatus A 601.

Upon receiving this instruction, the information processing apparatus C 603 makes the display screen sharing client establish a connection with the information processing apparatus A 601 at step S2102. As the display screen sharing client of the information processing apparatus C 603 seeks a connection, the connection management unit of the information processing apparatus A 601 controls the connection such that the client is connected to the display screen sharing server corresponding to the virtual desktop display screen on the left-hand side as registered in the information processing apparatus C 603. After the establishment of connection, the window 801 of the application A is shared as shown at (3) in FIG. 50.

Further, the connection management unit of the information processing apparatus C 603 establishes a cross-connection with the information processing apparatus A 601. If the virtual desktop display screen is position other than on the right-hand side of the real desktop display screen, arrangement is changed to place the virtual desktop display screen on the right-hand side of the real desktop display screen for the purpose of achieving cross-sharing.

At step S2103, the information processing apparatus C 603 instructs the information processing apparatus A 601 to connect to the information processing apparatus C 603. The connection control unit of the information processing apparatus A 601 establishes a connection with the information processing apparatus C 603 at step S2104, thereby completing a cross-connection.

After this, the window 802 of the application B on the information processing apparatus C 603 may be moved to the left to be displayed on the virtual desktop display screen. In this case, a shared display screen is displayed at the information processing apparatus A 601 as shown at (4) in FIG. 50. In the above-described process, the establishment of cross-connection is not mandatory.

### Embodiment 10

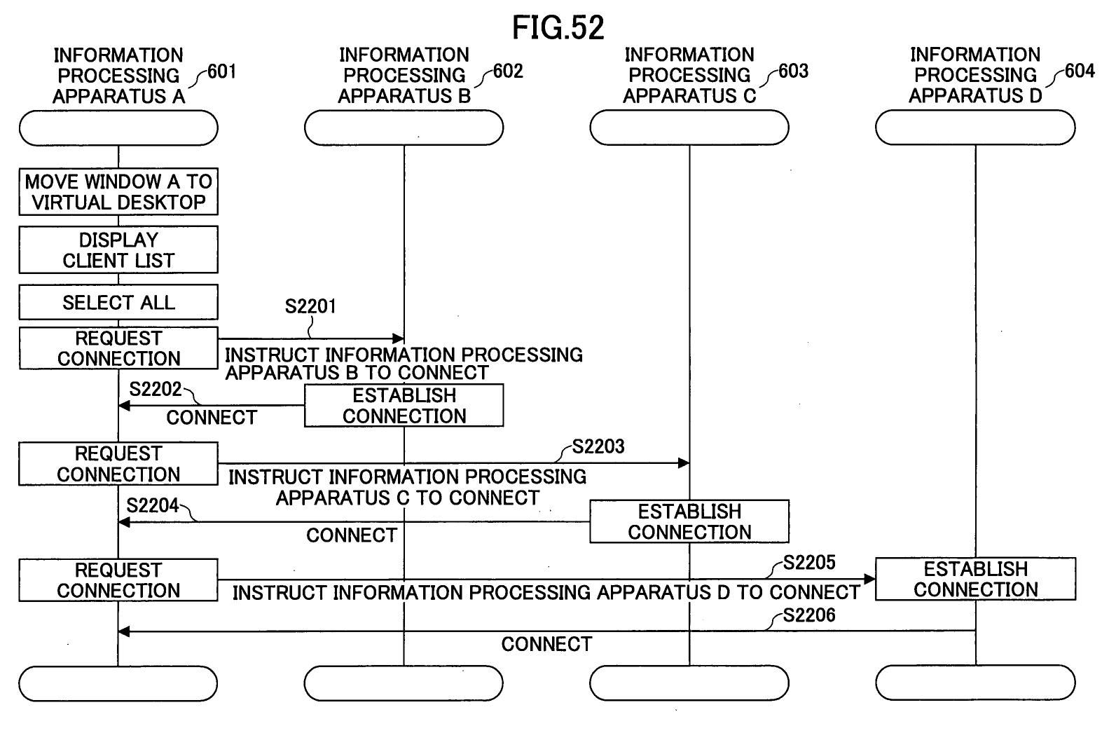

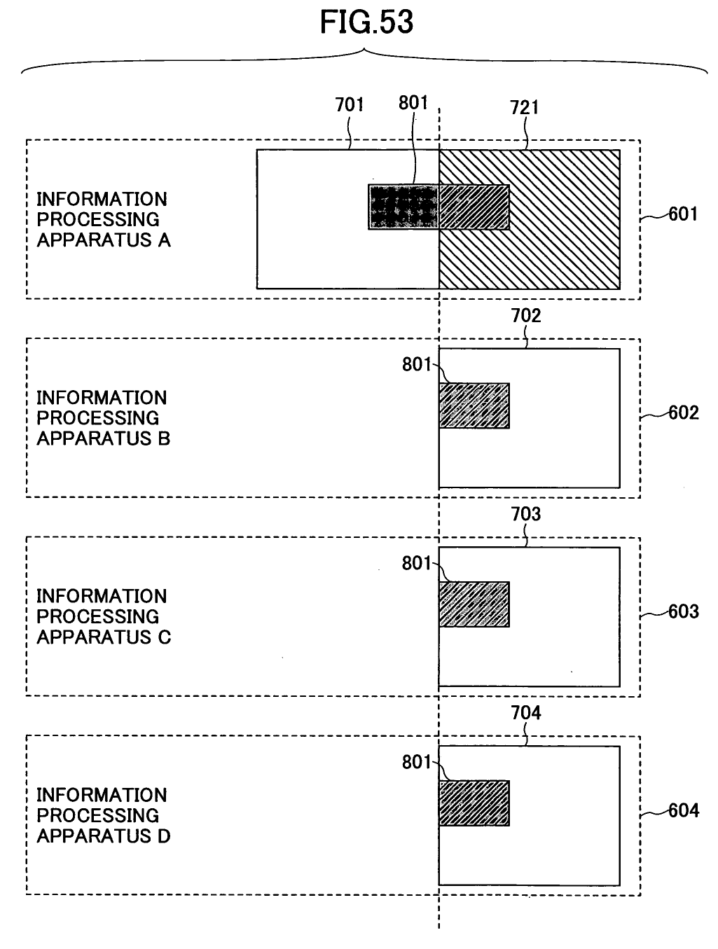

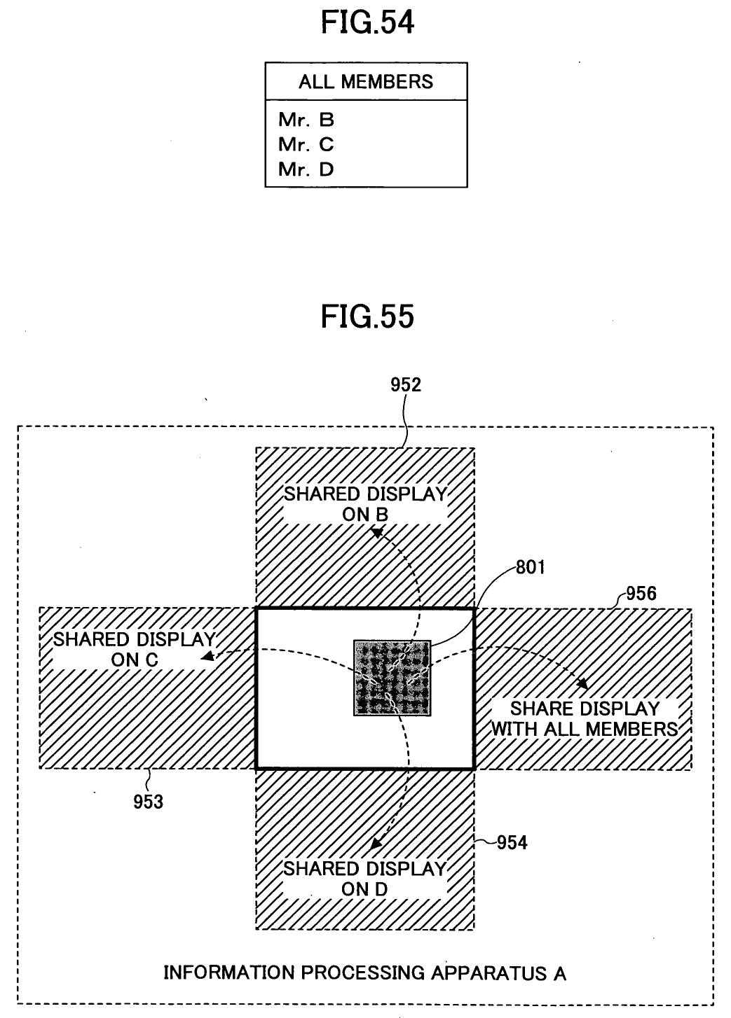

In the following, a description will be given of a case in which the information processing apparatus A 601 causes the other information processing apparatuses B 602, C 603, and D 604 having no connection yet to display the window of the application A as a shared display screen, with reference to FIG. 52, FIG. 53, and FIG. 54. FIG. 52 is a sequence chart of a process performed according to the tenth embodiment. FIG. 53 is an illustrative drawing showing the display screens of information processing apparatuses. FIG. 54 is a drawing showing an example of a list.

The information processing apparatus A 601 is operated first to move the window 801 of the application A to the right, such that the window is displayed on the virtual desktop display screen 721. In response, the connection management unit of the information processing apparatus A 601 detects the commencement of display screen sharing, and presents a registered client list as shown in FIG. 54. Namely, the names of the information processing apparatus B 602, the information processing apparatus C 603, and the information processing apparatus D 604, and a choice to present to all members are presented in list format. The user of the information processing apparatus A 601 selects all members. It should be noted that the names are registered in advance in such a manner as to be associated with IP addresses, for example.

In response, the connection management unit of the information processing apparatus A 601 instructs the other information processing apparatuses currently registered in the connection management unit, i.e., the information processing apparatuses B 602, C 603, and D 604, successively at steps S2201, S2203, and S2205 to connect with the information processing apparatus A 601. Upon receiving this instruction, the connection management unit of the information processing apparatuses B 602, C 603, and D 604 causes the display screen sharing client to establish a connection, so that each information processing apparatus is connected to the information processing apparatus A 601 at steps S2202, S2204, and S2206. After the establishment of connection, the window 801 of the application A running on the information processing apparatus A 601 is shared on the display screen of the information processing apparatuses B 602, C 603, and D 604 as shown in FIG. 53.

Further, the information processing apparatus A 601 establishes a cross-connection with each of the information processing apparatuses B 602, C 603, and D 604. With the information processing apparatus A 601 sharing display screens with all the other members, the window of the application running on the information processing apparatus B 602 may be moved to the left at the information processing apparatus B 602. In response, what is shown on the virtual desktop display screen of the information processing apparatus B 602 may be displayed on the right-hand side of the display screen of the information processing apparatus A 601.

Provision may be made such that the right to control is curbed in order to prevent the information processing apparatuses B 602, C 603, and D 604 from controlling the window 801 of the application A. This may be achieved by rejecting a control event at the display screen sharing server as the event comes from the information processing apparatuses B 602, C 603, and D 604.

### Embodiment 11

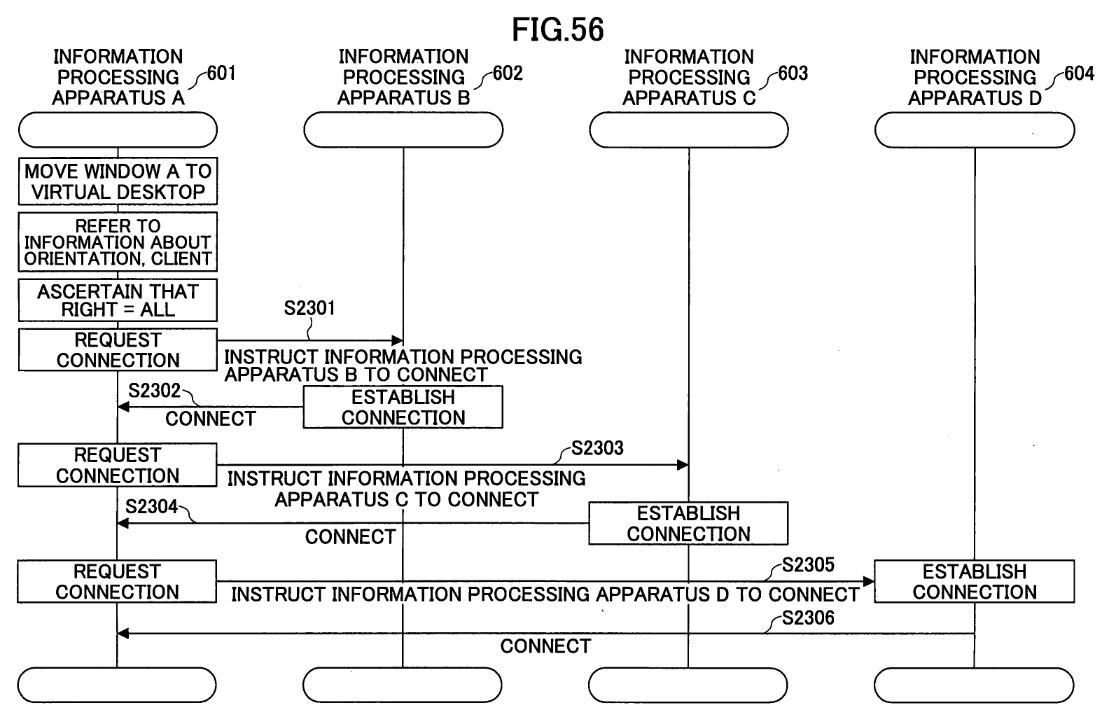

In the following, a description will be given, with reference to FIG. 55 and FIG. 56, of a process by which movement to a certain virtual desktop display screen causes the sharing of a display screen with all the members,.

The connection management unit of the information processing apparatus A 601 registers the information processing apparatuses B 602, C 603, and D 604 as virtual desktop display screens on the top, on the left, and on the bottom, respectively. Further, the connection management unit of the information processing apparatus A 601 registers all the members as a virtual desktop display screen on the right.

The virtual desktop display screen for sharing by all the members is registered as the one on the right-hand side of the real desktop display screen as shown in FIG. 55. Then, the window may be moved to the right. The connection management unit ascertains that the virtual desktop display screen 956 on the right-hand side is registered as the one to present a shared display screen to all the members. The connection management unit then instructs the connection management units of the information processing apparatuses B 602, C 603, and D 604 at steps S2301, 2303, and S2305, respectively, to connect with the information processing apparatus A 601. Upon receiving this instruction, each information processing apparatus establishes a connection with the information processing apparatus A 601 at step S2302, S2304, or S2306. After the establishment of connection with the information processing apparatuses B 602, C 603, and D604, the window of the application A is shared as shown in FIG. 53.

Further, provision may be made such that the information processing apparatus A 601 establishes a cross-connection with each of the information processing apparatus B 602, the information processing apparatus C 603, and the information processing apparatus D 604. With the information processing apparatus A 601 sharing display screens with all the other members, the window of the application running on the information processing apparatus B 602 may be moved to the left at the information processing apparatus B 602. In response, what is shown on the virtual desktop display screen of the information processing apparatus B 602 may be displayed on the right-hand side of the display screen of the information processing apparatus A 601.

Provision may be made such that the right to control is curbed in order to prevent the information processing apparatuses B 602, C 603, and D 604 from controlling the window 801 of the application A. This may be achieved by rejecting a control event at the display screen sharing server as the event comes from the information processing apparatuses B 602, C 603, and D 604.

### Embodiment 11

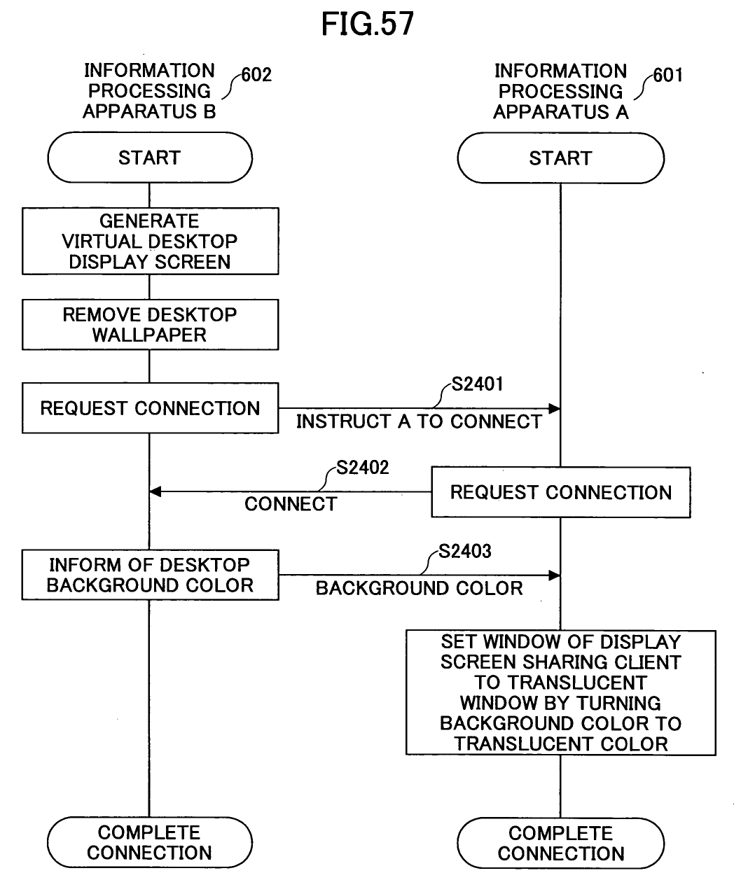

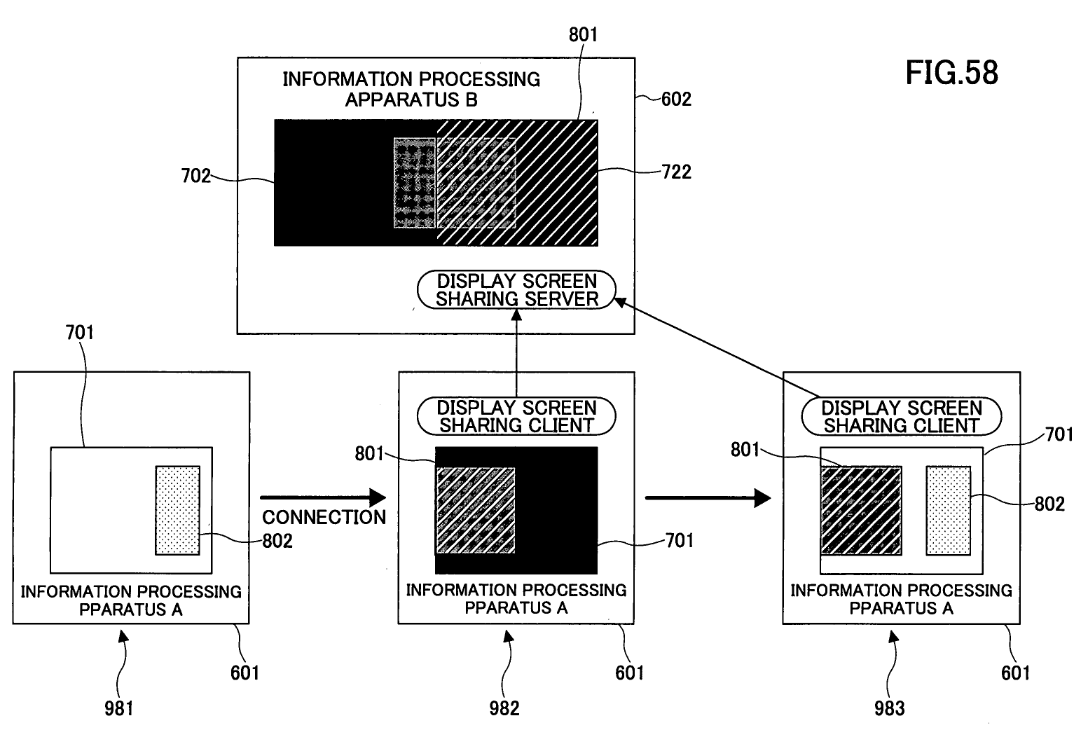

In the processes described heretofore, the embodiments have been directed to a case in which the window of an application is detected, and only the area corresponding to the displayed window is subjected to display screen sharing. In the following, a description will be given, with reference to FIG. 57 and FIG. 58, of a process by which the window of the display screen sharing client is presented as a translucent window through which the desktop area is visible FIG. 57 is a sequence chart of a process performed according to the eleventh embodiment. FIG. 58 is an illustrative drawing showing the display screen transition of a display screen sharing client according to the eleventh embodiment. As shown on a display screen 981 in FIG. 58, the window 802 of the application B is displayed on the desktop display screen 701 of the information processing apparatus A 601 before the establishment of connection.

In this example, the background color of the desktop of the information processing apparatus B 602 may be close to black (RGB values: R=0×0B, G=0×04, and B=0×08 in hexadecimal). The window 801 of the application A may be moved to the right-hand side of the desktop in an attempt to display the window at the information processing apparatus A 601.

In FIG. 58, the virtual desktop display screen of the information processing apparatus B 602 is shown with hash marks for illustration purposes. In actuality, however, its background color is the same as that of the real desktop display screen, and is represented as RGB:0B0408.

First, the information processing apparatus B 602 generates a virtual desktop display screen 722 in order to share the window 801 of the application A with the information processing apparatus A 601. There is a need to set the desktop background to a light color. If a wall paper setting is currently enabled, the setting is disabled so as to arrange that the wall paper is not shown.

Next, the information processing apparatus B 602 issues an instruction at step S2401 such that the display screen sharing client of the information processing apparatus A 601 is connected to the local display screen sharing server. In accordance with the instruction, the information processing apparatus A 601 causes the display screen sharing client to connect with the display screen sharing server of the information processing apparatus B 602 at step S2402. As a result, the virtual desktop display screen 722 of the information processing apparatus A 601 is displayed as a shared display screen on the display screen of the information processing apparatus B 602 as shown in FIG. 58.

In this state, the desktop display screen of the information processing apparatus B 602 is covered by the background color (RGB: 0B0408) of the desktop of the information processing apparatus A 601.

Upon confirming that the client is connected, the information processing apparatus B 602 informs the information processing apparatus A 601 at step S2403 of the background color of the desktop of the information processing apparatus B 602. That is, information indicative of RGB: 0B0408 is transmitted.

Upon receiving this information, the information processing apparatus A 601 turns the display screen of the display screen sharing client into a translucent window having a translucent color corresponding to RGB: 0B0408. This allows the desktop of the information processing apparatus A 601 to appear translucent.

Namely, like a display screen 983 shown in FIG. 58, the desktop of the information processing apparatus B 602 itself is not shown as a shared display screen, and only the window 801 of the application A is shown as a shared display screen.

Further, the window 802 of the application B running on the information processing apparatus A 601 is also shown without being obscured.

Further, the present invention is not limited to these embodiments, but various variations and modifications may be made without departing from the scope of the present invention.

The present application is based on Japanese priority application No. 2004-364633 filed on Dec. 16, 2004, with the Japanese Patent Office, the entire contents of which are hereby incorporated by reference.

What is claimed is:

1. A system for sharing a display screen, comprising:
a server information processing apparatus having a server function to provide a shared display screen to another information processing apparatus; and
a client information processing apparatus having a client function to become a client of said server function,
wherein said server function includes:
a virtual display screen generating unit configured to generate a virtual display screen for accommodating the shared display screen; and
a shared display screen acquiring unit configured to acquires image data of at least a portion of the shared display screen displayed on the virtual display screen,
and wherein said client function includes:
a shared display screen receiving unit configured to receive the image data from said server function; and
a shared display screen displaying unit configured to display at least a portion of the shared display screen on a shared display screen presenting area in response to the received image data.

2. The system as claimed in claim 1, wherein said server function further includes a disabling unit configured to disable displaying of the shared display screen displayed on the virtual display screen, and wherein the shared display screen is displayed on a real display screen instead of being displayed on the virtual display screen in response to a disabling of the displaying of the shared display screen by said disabling unit.

3. The system as claimed in claim 2, wherein said disabling unit is activated in response to detection that an entirety of the shared display screen is included in said virtual display screen.

4. The system as claimed in claim 1, wherein said client function further includes a disabling unit configured to disable displaying of the shared display screen displayed on the shared display screen presenting area, and wherein the shared display screen is displayed on a real display screen instead of being displayed on the virtual display screen in response to a disabling of the displaying of the shared display screen by said disabling unit.

5. The system as claimed in claim 4, wherein said disabling unit is activated in response to detection that an entirety of the shared display screen is included in said shared display screen presenting area.

6. The system as claimed in claim 1 wherein said client function further includes:
an action information acquiring unit configured to acquire action information regarding an action performed with respect to said shared display screen presenting area; and
an action information transmitting unit configured to transmit the acquired action information to said server information processing apparatus,
and wherein said server function further includes:
an action information receiving unit configured to receive the action information transmitted from said input information transmitting unit; and
an action information generating unit configured to reflect the received action information in the virtual display screen.

7. The system as claimed in claim 1, wherein said server function is capable of sharing a display screen with a plurality of client information processing apparatuses.

8. The system as claimed in claim 7, wherein said server function further includes a selecting unit configured to select one or more of said client information processing apparatuses with which a display screen is shared.

9. The system as claimed in claim 1, wherein said client information processing apparatus is capable of executing a plurality of client functions each identical to said client function, said client functions allowing said client information processing apparatus to share display screens with a plurality of server information processing apparatuses.

10. The system as claimed in claim 1, wherein at least one of said server function and said client function includes a drag-&-drop detecting unit configured to detect a drag-&-drop operation.

11. The system as claimed in claim 1, comprising two server information processing apparatuses one of which is said server information processing apparatus, wherein said client information processing apparatus shares display screens with said two server information processing apparatuses, and wherein a file indicated by a file identifier is transferred directly between said two server information processing apparatuses in response to detection that the file identifier is dragged from one of the shared display screens corresponding to one of said two server information processing apparatuses and dropped on another one of the shared display screens corresponding to another one of said two server information processing apparatuses.

12. A method of sharing a display screen between a plurality of information processing apparatuses, comprising:
generating a virtual display screen for accommodating a shared display screen;
acquiring image data of at least a portion of the shared display screen displayed on the virtual display screen; and
transmitting the acquired image data to another information processing apparatus.

13. The method as claimed in claim 12, further comprising:
receiving the transmitted image data; and
displaying at least a portion of the shared display screen in response to the received image data.

14. The method as claimed in claim 12, further comprising:
detecting a movement or size change of said shared display screen;
acquiring information regarding said shared display screen in response to the detection of a movement or size change; and
transmitting said information.

15. The method as claimed in claim 14, further comprising:
receiving the transmitted information; and
changing said shared display screen in response to the received information.

16. The system as claimed in claim 12, further comprising:
checking whether an entirety of the shared display screen is included in the virtual display screen; and
displaying the shared display screen on a real display screen rather than on the virtual display screen in response to detection that the entirety of the shared display screen is included in the virtual display screen.

17. A machine-readable medium having a program embodied therein for causing an information processing apparatus to share a display screen with another information processing apparatus, said program comprising the machine-code steps of:
generating a virtual display screen for accommodating a shared display screen;
acquiring image data of at least a portion of the shared display screen displayed on the virtual display screen; and
transmitting the acquired image data.

18. The machine-readable medium as claimed in claim 17, wherein said program further includes the machine-code steps of:
receiving the transmitted image data; and
displaying at least a portion of the shared display screen in response to the received image data.
